(19) United States
(12) Patent Application Publication
(10) Pub. No.: US 2023/0299900 A1
(43) Pub. Date: Sep. 21, 2023

(54) SYSTEM AND METHODS OF PUCCH ENHANCEMENT WITH INTRA-SLOT REPETITIONS TOWARDS MULTIPLE TRPs

(71) Applicant: Telefonaktiebolaget LM Ericsson (publ), Stockholm (SE)

(72) Inventors: Shiwei Gao, Nepean (CA); Yufei Blankenship, Kildeer, IL (US); Mattias Frenne, Uppsala (SE); Siva Muruganathan, Stittsville (CA); Jianwei Zhang, Solna (SE)

(21) Appl. No.: 18/020,090

(22) PCT Filed: Aug. 6, 2021
(86) PCT No.: PCT/IB2021/057286

§ 371 Date: Feb. 7, 2023

Related U.S. Application Data
(60) Provisional application No. 63/063,024, filed on Aug. 7, 2020.

(51) Int. Cl. H04L 5/00; H04W 72/232; H04W 72/21

(52) U.S. Cl. CPC H04L 5/0035; H04W 72/232; H04L 5/0023; H04W 72/21

(57) ABSTRACT

Systems and methods are disclosed for Physical Uplink Control Channel enhancement. In one embodiment, a method performed by a user equipment in the wireless communication network that includes multiple Transmission and Receiving Points (TRPs), each associated with a spatial relation or a Transmission Configuration Indication (TCI) state, includes receiving, from a base station, a configuration of a first and second spatial relations or a configuration of a first and second TCI states for an uplink channel resource, and an indication of N transmission repetitions of the uplink channel. Also, the method includes transmitting the uplink channel in N consecutive sub-slots, and applying the first spatial relation or the first TCI state to the uplink channel transmission repetitions in a first subset of the sub-slots and applying the second spatial relation or the second TCI state to the uplink channel transmission repetitions in a second subset of the sub-slots.

### RELATED APPLICATIONS

This application claims the benefit of provisional patent application Ser. No. 63/063,024, filed Aug. 7, 2020, the disclosure of which is hereby incorporated herein by reference in its entirety.

### TECHNICAL FIELD

The present disclosure relates to Physical Uplink Control Channel (PUCCH) reliability and latency.

### BACKGROUND

The next generation mobile wireless communication system (5G) or New Radio (NR), will support a diverse set of use cases and a diverse set of deployment scenarios. The later includes deployment at both low frequencies (below 6 GHz) and very high frequencies (up to 10's of GHz).

### NR Frame Structure and Resource Grid

NR uses Cyclic Prefix Orthogonal Frequency Division Multiplexing (CP-OFDM) in both Downlink (DL) (i.e., from a network node, gNB, or base station, to a User Equipment (UE) and Uplink (UL) (i.e., from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically on slot basis, an example is shown in FIG. 1 with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{μ}) kHz where ∈{0,1,2,3,4}. Δf=15 kHz is the basic subcarrier spacing. The slot durations at different subcarrier spacings is given by

$$\frac{1}{{2}^{μ}} m s .$$

In the frequency domain, a system bandwidth is divided into Resource Blocks (RBs), each corresponding to 12 contiguous subcarriers. The RBs are numbered starting with 0 from one end of the system bandwidth. The basic NR physical time-frequency resource grid is illustrated in FIG. 2, where only one RB within a 14-symbol slot is shown. One OFDM subcarrier during one OFDM symbol interval forms one Resource Element (RE).

Downlink and uplink data transmissions can be either dynamically or semi-persistently scheduled by a gNB. In case of dynamic scheduling, the gNB may transmit DL Control Information (DCI) in a downlink slot to a UE on PDCCH about data carried on PDSCH to the UE and/or data carried on PUSCH to be transmitted by the UE. In case of semi-persistent scheduling, periodic data transmission in certain slots can be configured and activated/deactivated.

For each transport block data transmitted over PDSCH, a Hybrid Automatic Repeat Request (HARQ) Acknowledgement (ACK) is sent in a UL Physical Uplink Control Channel (PUCCH) on whether it is decoded successfully or not. An ACK is sent if it is decoded successfully and a Non-acknowledgement (NACK) is sent otherwise.

PUCCH can also carry other UL control information (UCI) such as scheduling request (SR) and DL channel state information (CSI). PUCCH Formats

Five PUCCH formats are defined in NR, i.e., PUCCH formats 0 to 4. UE transmits UCI in a PUCCH using PUCCH format 0 if
the transmission is over 1 symbol or 2 symbols,
the number of HARQ-ACK information bits with positive or negative SR (HARQ-ACK/SR bits) is 1 or 2
   UE transmits UCI in a PUCCH using PUCCH format 1 if
the transmission is over 4 or more symbols,
the number of HARQ-ACK/SR bits is 1 or 2
   UE transmits UCI in a PUCCH using PUCCH format 2 if
the transmission is over 1 symbol or 2 symbols,
the number of UCI bits is more than 2
   UE transmits UCI in a PUCCH using PUCCH format 3 if
the transmission is over 4 or more symbols,
the number of UCI bits is more than 2,
   UE transmits UCI in a PUCCH using PUCCH format 4 if
the transmission is over 4 or more symbols,
the number of UCI bits is more than 2.

PUCCH formats 0 and 2 use one or two OFDM symbols while PUCCH formats 1, 3, and 4 can span from 4 to 14 symbols. Thus, PUCCH format 0 and 2 are referred to as short PUCCH while PUCCH formats 1, 3, and 4 are referred to as long PUCCH.

A PUCCH format 0 resource can be one or two OFDM symbols within a slot in time domain and one RB in frequency domain. UCI is used to select a cyclic shift of a computer-generated length 12 base sequence which is mapped to the RB. The starting symbol and the starting RB are configured by Radio Resource Control (RRC). In case of 2 symbols are configured, the UCI bits are repeated in 2 consecutive symbols.

A PUCCH format 2 resource can be one or two OFDM symbols within a slot in time domain and one or more RB in frequency domain. UCI in PUCCH Format 2 is encoded with Reed-Muller (RM) codes (≤11 bit UCI+Cyclic Redundancy Check (CRC)) or Polar codes (>11 bit UCI+CRC) and scrambled. In case of 2 symbols are configured, UCI is encoded and mapped across two consecutive symbols.

Intra-slot Frequency Hopping (FH) may be enabled in case of 2 symbols are configured for PUCCH formats 0 and 2. If FH is enabled, the starting Physical Resource Block (PRB) in the second symbol is configured by RRC. Cyclic shift hopping is used when 2 symbols are configured such that different cyclic shifts are used in the 2 symbols. FIG. 1 illustrates an example of one and two symbol short PUCCH without FH.

On the other hand, a PUCCH format 1 resource is 4-14 symbols long and 1 PRB wide per hop. A computer-generated length 12 base sequence is modulated with UCI and weighted with time-domain Orthogonal Cover Code (OCC) code. Frequency-hopping with one hop within the active UL Bandwidth Part (BWP) for the UE is supported and can be enabled/disabled by RRC. Base sequence hopping across hops is enabled in case of FH and across slots in case of no FH.

A PUCCH Format 3 resource is 4-14 symbols long and one or multiple PRB wide per hop. UCI in PUCCH Format 3 is encoded with RM codes (≤11 bit UCI+CRC) or Polar codes (>11 bit UCI+CRC) and scrambled.

A PUCCH Format 4 resource is also 4-14 symbols long but 1 PRB wide per hop. It has a similar structure as PUCCH format 3 but can be used for multi-UE multiplexing.

For PUCCH formats 1, 3, or 4, a UE can be configured by a number of slots, N_{PUCCH}^{repeat}, for repetitions of a PUCCH transmission by respective nrofSlots. For N N_{PUCCH}^{repeat}>1
the UE repeats the PUCCH transmission with the UCI over N_{PUCCH}^{repeat} slots,
a PUCCH transmission in each of the N_{PUCCH}^{repeat} has a same number of consecutive symbols,
a PUCCH transmission in each of the N_{PUCCH}^{repeat} slots has a same first symbol,
if the UE is configured to perform frequency hopping for PUCCH transmissions across different slots,
   the UE performs frequency hopping per slot,
   the UE transmits the PUCCH starting from a first PRB in slots with even number and starting from the second PRB in slots with odd number (The slot indicated to the UE for the first PUCCH transmission has number 0 and each subsequent slot until the UE transmits the PUCCH in N_{PUCCH}^{repeat} slots is counted regardless of whether or not the UE transmits the PUCCH in the slot), and
   the UE does not expect to be configured to perform frequency hopping for a PUCCH transmission within a slot, and
If the UE is not configured to perform frequency hopping for PUCCH transmissions across different slots and if the UE is configured to perform frequency hopping for PUCCH transmissions within a slot, the frequency hopping pattern between the first PRB and the second PRB is same within each slot.

FIG. 4 illustrates an example of 14-symbol and 7-symbol long PUCCH with intra-slot FH enabled. FIG. 5 illustrates an example of 14-symbol and 7-symbol long PUCCH with intra-slot FH disabled. FIG. 6 illustrates an example of PUCCH repetition in two slots with (a) inter-slot FH enabled and (b) inter-slot FH disabled while intra-slot FH enabled.

### Sub-Slot Based PUCCH Transmission

In NR Release 16, sub-slot based PUCCH transmission was introduced so that HARQ-Ack associated with a different type of traffic can be multiplexed in a same UL slot, each transmitted in a different sub-slot. The sub-slot size can be higher layer configured to either 2 symbols or 7 symbols. In case of sub-slot configuration each with 2 symbols, there are 7 sub-slots in a slot. In case of sub-slot with 7 symbols, there are two sub-slots in a slot.

### Spatial Relation Definition

Spatial relation is used in NR to refer to a relationship between an UL reference signal (RS) such as PUCCH demodulation reference signal (DMRS) and another RS, which can be either a DL RS (channel state information RS (CSI-RS) or Synchronization Signal Block (SSB)) or an UL RS (Sounding Reference Signal (SRS)).

If an UL RS is spatially related to a DL RS, it means that the UE should transmit the UL RS in the opposite (reciprocal) direction from which it received the DL RS previously. More precisely, the UE should apply the “same” transmitter (Tx) spatial filtering configuration for the transmission of the UL RS as the receiver (Rx) spatial filtering configuration it used to receive the spatially related DL RS previously. Here, the terminology ‘spatial filtering configuration’ may refer to the antenna weights that are applied at either the transmitter or the receiver for data/control transmission/reception. The DL RS is also referred as the spatial filter reference signal.

On the other hand, if a first UL RS is spatially related to a second UL RS, then the UE should apply the same Tx spatial filtering configuration for the transmission for the first UL RS as the Tx spatial filtering configuration it used to transmit the second UL RS previously.

In NR Release 16, a UE can be RRC configured with a list of up to 64 spatial relations for PUCCH. For a given PUCCH resource, one of the spatial relations is activated via a Media Access Control (MAC) Control Element (CE) message. The UE adjusts the Tx spatial filtering configuration for the transmission on that PUCCH resource according to the activated signaled spatial relation.

### URLLC Data Transmission Over Multiple TRPs

In NR Release 16, PDSCH transmission over multiple Transmission and Reception Points (TRPs) has been introduced for Ultra-Reliable Low Latency (URLLC) type of applications to improve PDSCH reliability, in which a PDSCH is repeated over two TRPs in either Spatial Division Multiplexing (SDM), Frequency Domain Multiplexing (FDM) or Time Domain Multiplexing (TDM) manner. In NR Release 17, it has been proposed to further introduce PUCCH enhancement with multiple TRPs. One possible approach is to repeat a PUCCH towards different TRPs.

### SUMMARY

Systems and methods are disclosed herein for Physical Uplink Control Channel (PUCCH) enhancement utilizing intra-slot transmission repetitions towards multiple transmission and receiving points (TRPs). In one embodiment, a method performed by a User Equipment (UE) in the wireless communication network that includes two or more TRPs, each associated with a spatial relation or a Transmission Configuration Indication state (TCI), includes receiving, from a base station in the wireless communication network, a configuration of a first spatial relation and a second spatial relation or a configuration of a first TCI state and a second TCI state for an uplink channel resource, and an indication of N transmission repetitions of the uplink channel. Herein N is an integer greater than one. In addition, the method performed by the UE also includes transmitting the uplink channel in N consecutive sub-slots, and applying the first spatial relation or the first TCI state to the uplink channel transmission repetitions in a first subset of the sub-slots and applying the second spatial relation or the second TCI state to the uplink channel transmission repetitions in a second subset of the sub-slots.

In one embodiment of the method performed by the UE, each of the first TCI state and the second TCI state is one of a unified TCI state that can be used for both downlink and uplink channel transmissions and an uplink TCI state that can be used only for uplink channel transmissions.

In one embodiment of the method performed by the UE, the uplink channel is a Physical Uplink Control Channel (PUCCH).

In one embodiment of the method performed by the UE, each of the first spatial relation and the second spatial relation includes one or more of 1) a Synchronization Signal Block (SSB) index, a Channel State Information Reference Signal (CSI-RS) index, or a Sounding Reference Signal (SRS) index, which are used to determine a spatial filter to be used for uplink channel transmission; 2) a pathloss reference signal index; and 3) one or more power control parameters.

In one embodiment of the method performed by the UE, each of each of the first TCI state and the second TCI state includes one or more of 1) a SSB index, a CSI-RS index, or a SRS index, which are used to determine a spatial filter to be used for uplink channel transmission; 2) a pathloss reference signal index; and 3) one or more power control parameters.

In one embodiment of the method performed by the UE, a total number of sub-slots in the first subset of the sub-slots and the second subset of the sub-slots is equal to the number of transmission repetitions.

In one embodiment of the method performed by the UE, the first subset of the sub-slots and the second subset of the sub-slots are in a same slot.

In one embodiment of the method performed by the UE, each of the sub-slots includes a number of Orthogonal Frequency Division Multiplexing (OFDM) symbols.

In one embodiment of the method performed by the UE, the first subset of the sub-slots and the second subset of the sub-slots are non-overlapping in time.

In one embodiment of the method performed by the UE, the same uplink channel resource is allocated in each of the sub-slots.

In one embodiment of the method performed by the UE, the uplink channel is one of PUCCH formats 0 to 4.

In one embodiment of the method performed by the UE, the first subset of the sub-slots includes one or more sub-slots, and the second subset of the sub-slots includes one or more sub-slots.

In one embodiment of the method performed by the UE, cyclic mapping of the first spatial relation and the second spatial relation or cyclic mapping of the first TCI state and the second TCI state is configured over the repetitions of the uplink channel. Herein, the first spatial relation or the first TCI state is applied to every other repetition of the uplink channel starting from the first repetition and the second spatial relation or the second TCI state is applied to the remaining repetitions.

In one embodiment of the method performed by the UE, every other repetition of the uplink channel starting from the first repetition are transmitted in the first subset of the sub-slots, and the remaining repetitions are transmitted in the second subset of the sub-slots.

In one embodiment of the method performed by the UE, sequential mapping of the first spatial relation and the second spatial relation or sequential mapping of the first TCI state and the second TCI state is configured over the repetitions of the uplink channel. Herein, the first spatial relation or first TCI state is applied to every other two consecutive repetitions in time of the uplink channel starting from the first two consecutive repetitions and the second spatial relation or second TCI state is applied to the remaining repetitions.

In one embodiment of the method performed by the UE, every other two consecutive repetitions of the uplink channel starting from the first repetition are transmitted in the first subset of the sub-slots, and the remaining repetitions are transmitted in the second subset of the sub-slots.

According to one embodiment, the method performed by the UE further includes receiving, from the base station, a second configuration of multiple numbers of transmission repetitions for the uplink channel. Herein, the number of transmission repetitions of the uplink channel is selected from the multiple numbers of transmission repetitions for the uplink channel depending on whether one or more of the following conditions are met: 1) two TCI states are indicated in a transmission configuration indication field of a Downlink Control Information (DCI) format scheduling an associated Physical Downlink Shared Channel (PDSCH), for which a corresponding Hybrid Automatic Repeat Request Acknowledgement (HARQ-ACK) is carried on the uplink channel; 2) an associated PDSCH corresponds to a particular PDSCH scheme; 3) a priority indicator field of a DCI scheduling an associated PDSCH is set to “1”; 4) an associated PDSCH is scheduled by DCI format 1_2; 5) the resource for the uplink channel is activated with two TCI states; and 6) a certain Uplink Control Information (UCI) type is carried by the uplink channel.

According to one embodiment, the method performed by the UE further includes receiving, from the base station, a second configuration of multiple numbers of the transmission repetitions for the uplink channel. Herein, the number of transmission repetitions of the uplink channel is selected from the multiple numbers of transmission repetitions for the uplink channel depending on a traffic type that the uplink channel is associated with.

According to one embodiment, the method performed by the UE further includes receiving, from the base station, one or more configurations for selecting the number of transmission repetitions of the uplink channel. Herein, one of the one or more configurations is dynamically indicated in DCI.

In one embodiment of the method performed by the UE, an UCI is carried by the uplink channel.

In one embodiment of the method performed by the UE, the number of transmission repetitions of the uplink channel varies with a type of the UCI.

In one embodiment of the method performed by the UE, the type of the UCI is one of: HARQ-ACK, SR, CSI, or two or more of HARQ-ACK, SR, and CSI multiplexed together.

According to one embodiment, the method performed by the UE further includes dropping one transmission repetition of the uplink channel when such transmission repetition of the uplink channel is overlapping with another uplink channel with a higher priority.

According to one embodiment, the method performed by the UE further includes multiplexing one transmission repetition of the uplink channel with another overlapping uplink channel with a same priority.

According to one embodiment, the method performed by the UE further includes omitting a corresponding transmission repetition if the transmission collides with an invalid symbol.

According to one embodiment, the method performed by the UE further includes, if the transmission collides with an invalid symbol, delaying a corresponding transmission repetition until enough valid symbols are available.

According to one embodiment, the method performed by the UE further includes if the uplink channel carrying a HARQ-ACK corresponding to a PDSCH carrying a Media Access Control (MAC) Control Clement (CE) command from the base station is transmitted in slot n, applying the MAC CE command starting from a first slot 3 milli-seconds after slot n.

In one embodiment of the method performed by the UE, the configuration can be via a Radio Resource Control, RRC, message, a MAC CE command or both.

Corresponding embodiments of a UE in a wireless communication network that includes two or more TRP, each associated with a spatial relation or TCI state are also disclosed. In one embodiment, the UE is adapted to receive, from a base station in the wireless communication network, a configuration of a first spatial relation and a second spatial relation or a configuration of a first TCI state and a second TCI state for an uplink channel resource, and an indication of N transmission repetitions of the uplink channel. Herein, N is an integer greater than one. In addition, the UE is adapted to transmit the uplink channel in N consecutive sub-slots, and applying the first spatial relation or the first TCI state to the uplink channel transmission repetitions in a first subset of the sub-slots and applying the second spatial relation or the second TCI state to the uplink channel transmission repetitions in a second subset of the sub-slots.

In one embodiment, a UE in a wireless communication network that includes two or more TRP, each associated with a spatial relation or TCI state comprises one or more transmitters, one or more receivers, and processing circuitry associated with the one or more transmitters and the one or more receivers. The processing circuitry is configured to cause the UE to receive, from a base station in the wireless communication network, a configuration of a first spatial relation and a second spatial relation or a configuration of a first TCI state and a second TCI state for an uplink channel resource, and an indication of N transmission repetitions of the uplink channel. Herein, N is an integer greater than one. In addition, the processing circuitry is configured to cause the UE to further transmit the uplink channel in N consecutive sub-slots, and applying the first spatial relation or the first TCI state to the uplink channel transmission repetitions in a first subset of the sub-slots and applying the second spatial relation or the second TCI state to the uplink channel transmission repetitions in a second subset of the sub-slots.

Embodiments of a method performed by a base station in a wireless communication network that includes two or more TRPs, each associated with a spatial relation or TCI state are also disclosed. In one embodiment, the method includes providing, to a UE in the wireless communication network, a configuration of a first spatial relation and a second spatial relation or a configuration of a first TCI state and a second TCI state for an uplink channel resource, and an indication of N transmission repetitions for transmitting the uplink channel. Herein, N is an integer greater than one.

In one embodiment of the method performed by the base station, each of the first TCI state and the second TCI state is one of a unified TCI state that can be used for both downlink and uplink channel transmissions and an uplink TCI state that can be used only for uplink channel transmissions.

In one embodiment of the method performed by the base station, the uplink channel is a PUCCH.

In one embodiment of the method performed by the base station, each of the first spatial relation and the second spatial relation includes one or more of 1) a Synchronization Signal Block (SSB) index, a Channel State Information Reference Signal (CSI-RS) index, or a Sounding Reference Signal (SRS) index, which are used to determine a spatial filter to be used for uplink channel transmission; 2) a pathloss reference signal index; and 3) one or more power control parameters.

In one embodiment of the method performed by the base station, each of each of the first TCI state and the second TCI state includes one or more of 1) a SSB index, a CSI-RS index, or a SRS index, which are used to determine a spatial filter to be used for uplink channel transmission; 2) a pathloss reference signal index; and 3) one or more power control parameters.

In one embodiment of the method performed by the base station, the uplink channel is one of PUCCH formats 0 to 4.

In one embodiment of the method performed by the base station, cyclic mapping of the first spatial relation and the second spatial relation or cyclic mapping of the first TCI state and the second TCI state is configured over the repetitions of the uplink channel.

In one embodiment of the method performed by the base station, sequential mapping of the first spatial relation and the second spatial relation or sequential mapping of the first TCI state and the second TCI state is configured over the repetitions of the uplink channel.

According to one embodiment, the method performed by the base station further includes providing, to the UE, a second configuration of multiple numbers of transmission repetitions for the uplink channel. Herein, the number of transmission repetitions of the uplink channel is selected from the multiple numbers of transmission repetitions for the uplink channel depending on whether one or more of the following conditions are met: 1) two TCI states are indicated in a transmission configuration indication field of a DCI format scheduling an associated PDSCH, for which a corresponding Hybrid Automatic Repeat Request Acknowledgement, HARQ-ACK, is carried on the uplink channel; 2) an associated PDSCH corresponds to a particular scheme; 3) a priority indicator field of a DCI scheduling an associated PDSCH is set to “1”; 4) an associated PDSCH is scheduled by DCI format 1_2; 5) the resource for the uplink channel is activated with two TCI states; and 6) a certain UCI type is carried by the uplink channel.

According to one embodiment, the method performed by the base station further includes providing, to the UE, a second configuration of multiple numbers of the transmission repetitions for the uplink channel. Herein, the number of transmission repetitions of the uplink channel is selected from the multiple numbers of transmission repetitions for the uplink channel depending on a traffic type the uplink channel is associated with.

According to one embodiment, the method performed by the base station further includes providing, to the UE, one or more configurations for selecting the number of transmission repetitions of the uplink channel, wherein one of the one or more configurations is dynamically indicated in DCI.

In one embodiment of the method performed by the base station, UCI is carried by the uplink channel, where the number of transmission repetitions of the uplink channel varies with a type of the UCI. The type of the UCI is one of: HARQ ACK, SR, CSI, or two or more of HARQ-ACK, SR, and CSI multiplexed together.

Corresponding embodiments of a base station in a wireless communication network that includes two or more TRP, each associated with a spatial relation or TCI state are also disclosed. In one embodiment, the base station is adapted to provide, to a UE in the wireless communication network, a configuration of a first spatial relation and a second spatial relation or a configuration of a first TCI state and a second TCI state for an uplink channel resource, and an indication of N transmission repetitions for transmitting the uplink channel. Herein, N is an integer greater than one.

In one embodiment, a base station in a wireless communication network that includes two or more TRP, each associated with a spatial relation or TCI state comprises processing circuitry configured to cause the base station to provide, to a UE in the wireless communication network, a configuration of a first spatial relation and a second spatial relation or a configuration of a first TCI state and a second TCI state for an uplink channel resource, and an indication of N transmission repetitions for transmitting the uplink channel. Herein, N is an integer greater than one.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a typical slot in Third Generation Partnership Project (3GPP) New Radio (NR).

FIG. 2 illustrates a basic NR physical time-frequency resource grid.

FIG. 2 illustrates one example of one-symbol and two-symbol short Physical Uplink Control Channel (PUCCH) without Frequency Hopping (FH).

FIG. 4 illustrates one example of 14-symbol PUCCH and 7-symbol long PUCCH with intra-slot FH enabled.

FIG. 5 illustrates one example of 14-symbol PUCCH and 7-symbol long PUCCH with intra-slot FH disabled.

FIG. 6 illustrates one example of PUCCH repetition in two slots with (a) inter-slot FH enabled and (b) inter-slot FH disabled while intra-slot FH enabled.

FIG. 7 illustrates one example of a cellular communications system in which embodiments of the present disclosure may be implemented.

FIG. 8 illustrates one example of intra-slot PUCCH repetitions with FH for two different transmission and receiving points (TRPs) in accordance with embodiments of the present disclosure.

FIG. 9 illustrates details of PUCCH-FormatConfig field.

FIGS. 10 and 11 illustrate one example of sub-slot based PUCCH repetitions with FH for two different TRPs in accordance with embodiments of the present disclosure.

FIG. 12 illustrates one example of cyclic mapping between PUCCH transmission occasions and TRPs in accordance with embodiments of the present disclosure.

FIG. 13 illustrates one example of sequentially mapping between PUCCH transmission occasions and TRPs in accordance with embodiments of the present disclosure.

FIGS. 14 and 15 illustrate one example of collision handling in PUCCH repetition for two different TRPs in accordance with embodiments of the present disclosure.

FIG. 16 illustrates the operation of a base station and a User Equipment (UE) for PUCCH repetition in accordance with embodiments of the present disclosure.

FIGS. 17, 18, and 19 are schematic block diagrams of example embodiments of a radio access node, or more generally a network node, in which embodiments of the present disclosure may be implemented.

FIGS. 20 and 21 are schematic block diagrams of example embodiments of a wireless communication device (e.g., a UE) in which embodiments of the present disclosure may be implemented.

FIG. 22 illustrates an example embodiment of a communication system in which embodiments of the present disclosure may be implemented.

FIG. 23 illustrates example embodiments of the host computer, base station, and UE of FIG. 22.

FIGS. 24, 25, 26, and 27 are flow charts that illustrate example embodiments of methods implemented in a communication system such as that of FIG. 22.

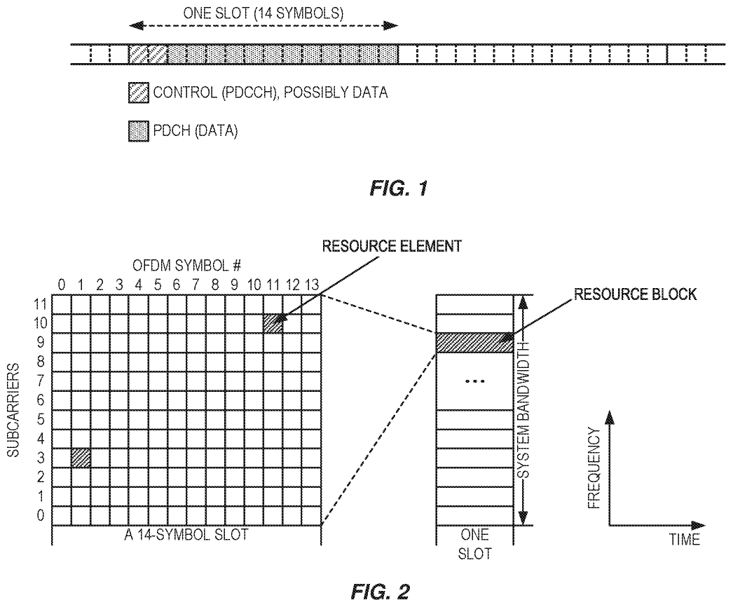

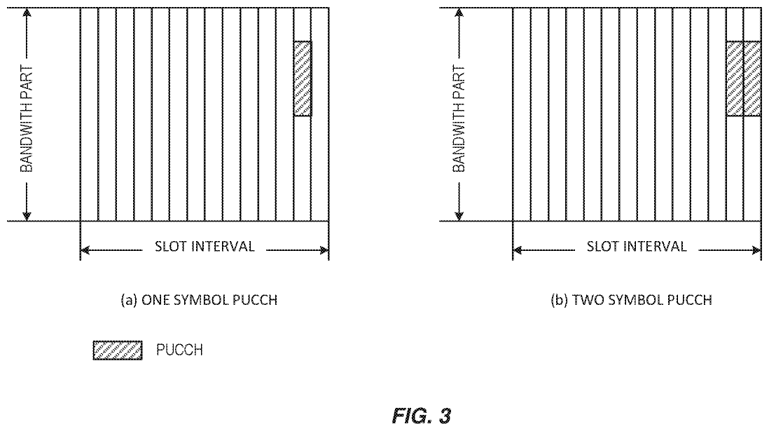

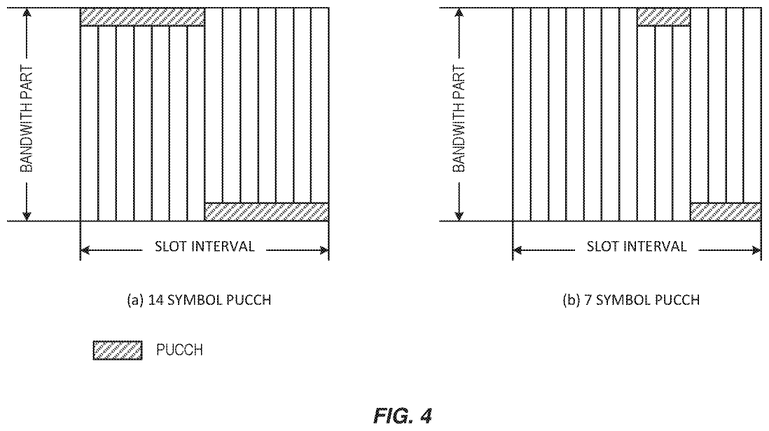

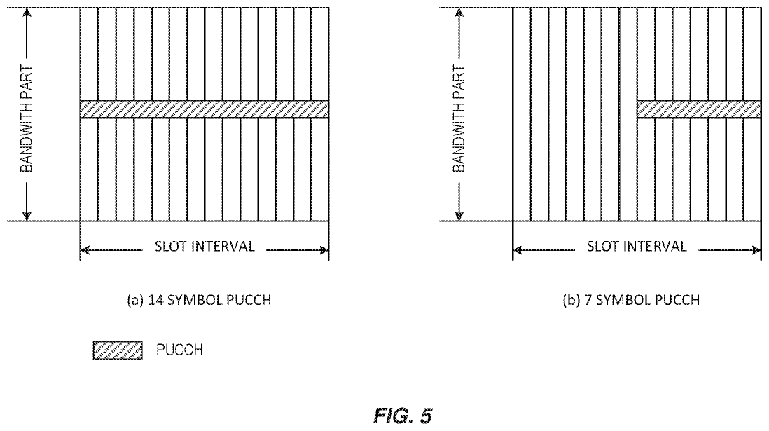

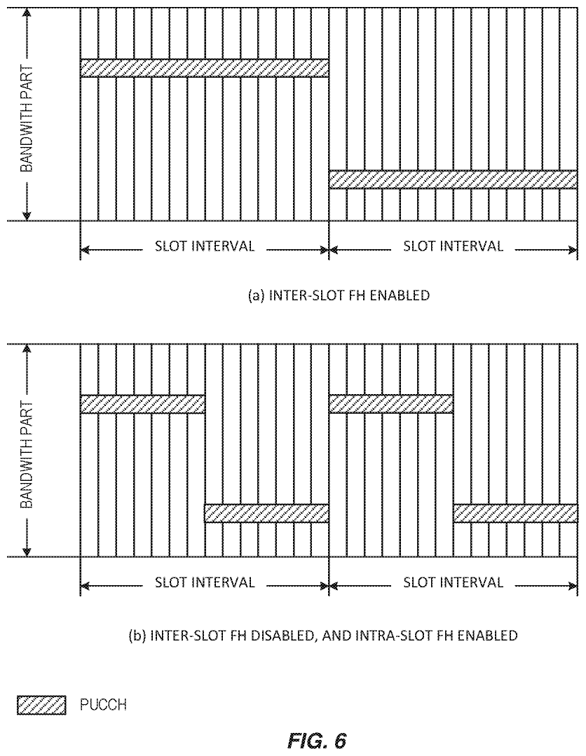

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Transmission/Reception Point (TRP): In some embodiments, a TRP may be a network node, radio head, a spatial relation or a Transmission Configuration Indicator (TCI) state. A TRP may be represented by a spatial relation or a TCI state in some embodiments. In some embodiments, a TRP may be using multiple TCI states.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). Although PUCCH reliability for PUCCH formats 1, 3 and 4 can be increased with inter-slot repetition over multiple TRPs, it also introduces extra delays. For some applications, such as Ultra-Reliable Low Latency (URLLC) applications, besides PUCCH reliability, low latency is also required. How to balance between PUCCH reliability and PUCCH latency is an issue. In addition, when mixed enhanced Mobile Broadband (eMBB) and URLLC traffic are served, the corresponding required reliability and latency are different, how to determine the number of repetitions for each type of traffic is another issue.

Certain aspects of the present disclosure and their embodiments may provide solutions to the aforementioned or other challenges. In this disclosure, different ways of PUCCH enhancement are disclosed. In one embodiment, a PUCCH is repeated two or more times within a slot, each toward a TRP, and a different PUCCH repetition may be associated with a different TRP. An association between a PUCCH transmission and a TRP for reception can be made using a spatial relation or a unified TCI state.

In addition, embodiments of a method of applying different number of PUCCH repetitions based on the associated Physical Downlink Shared Channel (PDSCH) (i.e., the PDSCH with its corresponding HARQ-ACK carried by the PUCCH) are also disclosed, in which different number of PUCCH repetitions may be used for different traffic types (e.g., PDSCH with different priorities, eMBB or URLLC) that a PUCCH is associated with.

Certain embodiments may provide one or more of the following technical advantage(s). One benefit of intra-slot repetition towards different TRPs is to improve PUCCH reliability in case that the channel to the TRP is blocked while at the same time keeping the latency low. Using different number of PUCCH repetitions for different traffic is beneficial in case of mixed eMBB and URLLC traffic being served simultaneously, which has different reliability requirements (i.e., requiring different number of repetitions). In such case, a small number of repetitions or even no repetition may be used for a PUCCH associated with eMBB traffic to save PUCCH resources and potentially UE battery power consumption.

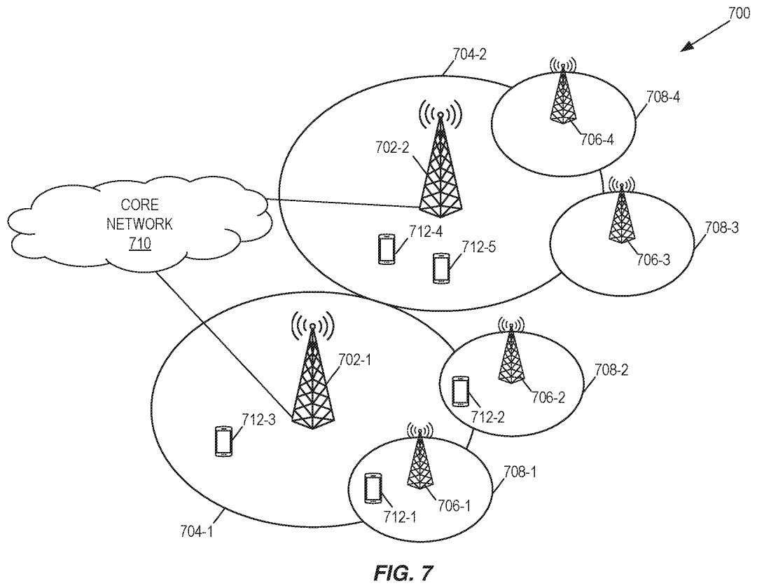

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC). In this example, the RAN includes base stations 702-1 and 702-2, which in the 5GS include NR base stations (gNBs) and optionally next generation eNBs (ng-eNBs) (e.g., LTE RAN nodes connected to the 5GC), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or Remote Radio Heads (RRHs), or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

### Intra Slot PUCCH Repetition Towards Multiple TRPs

In one embodiment, a UL control information (UCI) carried by one of the PUCCH formats is repeated within a slot multiple times, each toward a different TRP.

Note here in the following of the present disclosure that “transmission toward” in this aspect means that the UE is adjusting its direction of large or maximum radiation and/or transmit power and/or transmission timing for an intended reception by a given TRP. For example, a UE transmit a beam pointing in the direction of the desired TRP or selecting a directive antenna panel for transmission at the UE that is facing towards a certain desired direction towards a TRP. Also note that a certain TRP can be described in specifications by a spatial relation, a unified TCI state (a TCI state that can be used for both DL and UL indication) or an UL TCI state. Hence “transmission toward” TRP1 and TRP2 can equivalently be described as using e.g., first spatial relation and second spatial relation for the PUCCH transmission, respectively.

It should also be noted that even in Release 15 of NR, reception of an uplink signal by multiple TRPs is possible since which node that receives a certain message in uplink is transparent to the UE. It may be so that an uplink transmitted by a Release 15 UE is received by two TRPs. The distinction here is that by introducing the framework of “transmission toward”, the UE is “made aware” that its multiple transmissions are intended for more than one TRP, and hence by specification, the transmission can be optimized, in terms of beam direction, power control and timing.

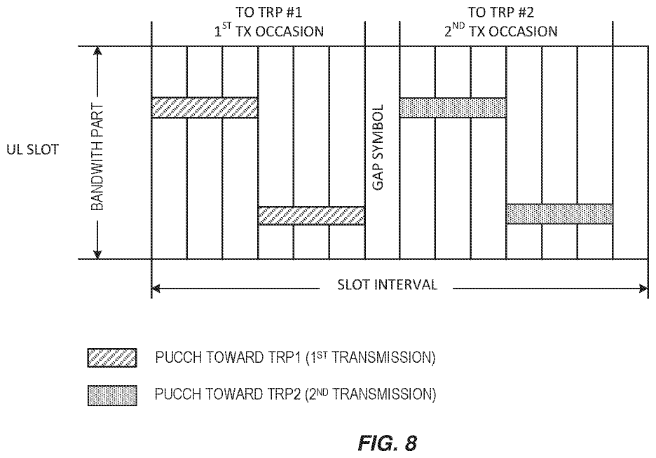

An example is shown in FIG. 8, where a PUCCH with FH is repeated twice in a slot. A gap may be configured between the two repetitions to allow time for a UE to switch its receive panels or beams in high carrier frequencies (frequencies above 20 GHz, e.g., FR2). The same number of symbols, the starting first and the second RBs are used in the repetition, i.e., the second transmission occasion. The 1st transmission occasion is toward TRP1 and the second transmission is toward TRP2. In case of channel blocking as it occurs often in FR2, this kind of repetition can be used to reduce the blocking probability. Note, as discussed above, the term TRP may not necessarily be captured in 3GPP specifications. A TRP may instead be represented in 3GPP specifications by a spatial relation, a unified TCI state (discussed in Release 17 of NR) or a UL TCI state. Two or more spatial relations or two or more UL TCI or two or more unified TCI states may be activated for a PUCCH resource for transmission to two or more TRPs.

In some embodiments, a gap symbol(s) as shown FIG. 8 may be configured to the UE either in PUCCH-Config information element (see 3GPP TS 38.331) or a field within PUCCH-Config. In one specific embodiment, the gap symbol(s) is configured and controlled via a parameter ‘startingSymbolOffset’ as part of the PUCCH-FormatConfig field within the PUCCH-Config as shown in FIG. 9.

If the parameter ‘startingSymbolOffset’ is enabled, then a gap symbol(s) is present between the first transmission occasion and the second transmission occasion as shown in FIG. 8. If the parameter ‘startingSymbolOffset’ is not configured, then the first transmission occasion of PUCCH and the second transmission occasion of PUCCH do not have a gap symbol(s) in the middle, and the UE transmits the second transmission occasion of PUCCH in the symbol after the last symbol of the first transmission occasion of PUCCH.

Note that in some other embodiments the gap between the two PUCCH transmission occasions may be a configurable number of integer symbols. In this embodiment, the parameter ‘startingSymbolOffset’ can be an integer between 0 and a non-negative integer K. Then, the starting symbol of the second PUCCH transmission occasion has K symbol offset relative to the last symbol of the first PUCCH transmission occasion.

### Sub-Slot Based PUCCH Repetition Towards Multiple TRPs

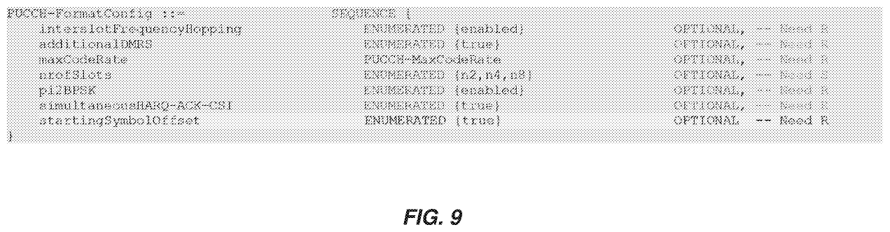

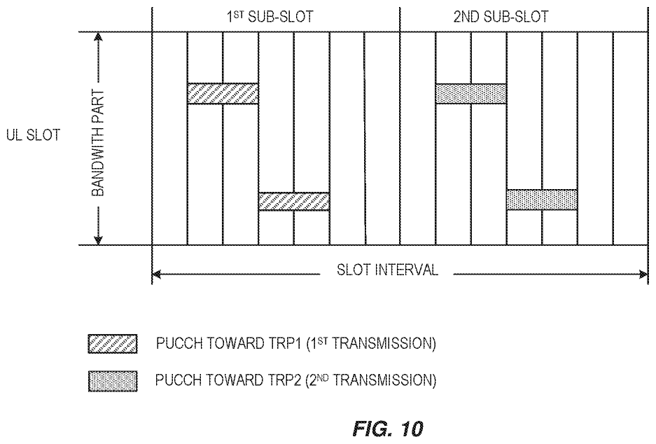

In one embodiment, a PUCCH may be repeated in sub-slot level. An example is shown in FIG. 10, where a PUCCH is repeated twice in two sub-slot each with 7 symbols with the 1^{st} transmission occasion towards TRP1 and the second transmission occasion towards TRP2. The same time and frequency resource is used for the two repetitions in each sub-slot, i.e., the starting symbol (referenced to the start of sub-slot), number of symbols, and the starting Resource Blocks (RBs) for the first and second frequency hops.

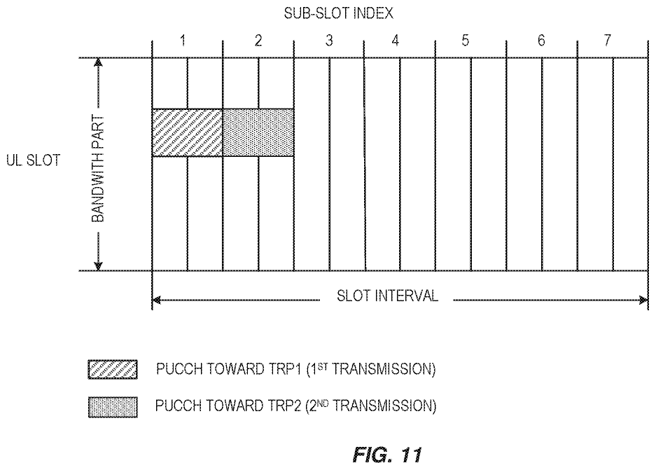

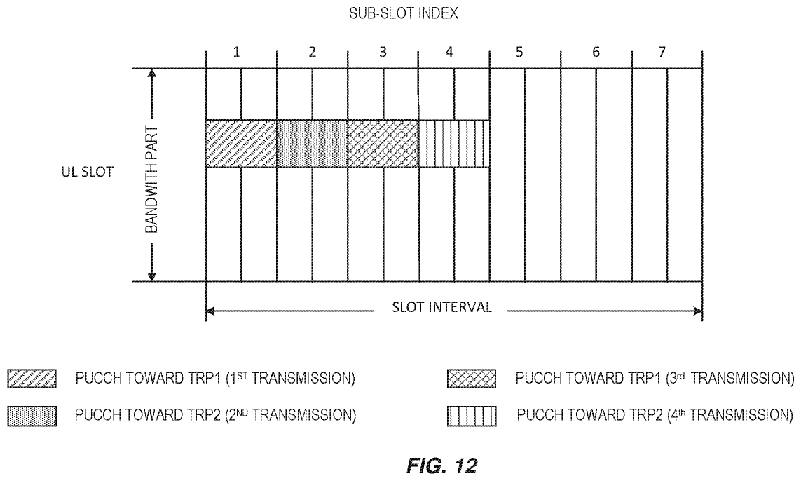

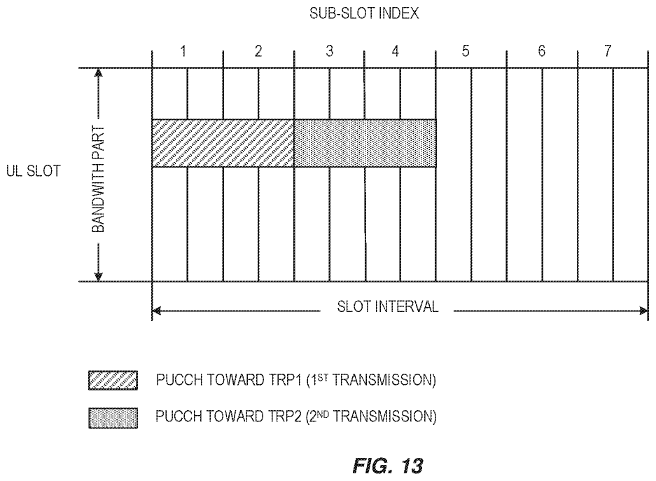

FIG. 11 is another example of sub-slot based PUCCH repetition with 2 symbols per sub-slot. The number of sub-slots based repetitions can be more than 2. In that case, the patterns towards (keep in mind that “toward” may be specified by spatial relation or UL or unified TCI state) different TRPs can be alternated among the TRPs (i.e., cyclic based), an example is shown in FIG. 12. Alternatively, the mapping can be sequentially one TRP after another, an example is shown in FIG. 13. While the examples shown do not use frequency hopping, it is possible that frequency hopping is configured together with repetitions, e.g., extending examples in FIG. 11 to FIG. 13 with FH within repetitions (e.g., having different starting RBs for the first and the second symbols in each repetition) or with FH across repetitions (e.g., having different starting RBs for different repetitions). Sub-slot PUCCH repetition can be used for all PUCCH formats supported (including PUCCH formats 0 and 2) in a sub-slot. The repetition may also be over more than one slot.

### Indication of Number of PUCCH Repetitions

In NR Release 15, the number of slot-based PUCCH repetitions is configured by higher layers (such as Radio Resource Control (RRC) signaling between the gNB and the UE) for each PUCCH format. Considering mixed traffic types for a UE and different traffic types may have different reliability and latency requirements, different number of repetitions (either slot-based or sub-slot based) may be needed for PUCCH associated with different traffic types.

In one embodiment, for each PUCCH format, multiple numbers of repetitions may be configured, and depending on the traffic type that a PUCCH is associated with (or the physical layer priority of the UCI carried by the PUCCH), a different repetition number may be used.

In another embodiment, the number of repetitions for the associated PUCCH varies with the UCI content type, where the UCI content type can be: Hybrid Automatic Repeat Request (HARQ) Acknowledgement (ACK), Scheduling Request (SR), Channel State Information (CSI), where the CSI can be further divided into CSI-part1 and CSI-part2, or two or more of HARQ-ACK/SR/CSI multiplexed together.

For example, one RRC parameter signaled from the gNB to the UE provides the number of repetitions for PUCCH carrying SR, and a different RRC parameter provides the number of repetitions for PUCCH carrying HARQ-ACK. The various types of UCI can be provided with physical layer priority level as well, e.g., SR of high priority and SR of low priority. Then the number of PUCCH repetitions may depend on UCI type, and/or the physical layer priority of the UCI, where the UCI is carried by the PUCCH. If the PUCCH carries a mixture of various UCI types, then the number of PUCCH repetitions may be determined by the most important UCI being carried. For example, if UCI types are ranked from more important to less important by: HARQ-ACK>SR>CSI with HARQ-ACK and SR having higher priority and CSI having lower priority, then the number of PUCCH repetitions is determined by that of HARQ-ACK (i.e., the most important UCI being carried, since HARQ-ACK is more important than SR), if the PUCCH carries a mixture of {SR, HARQ-ACK}.

In another embodiment, if a PUCCH carrying a UCI type (e.g., HARQ-ACK) is scheduled by a DL Control Information (DCI), then the scheduling DCI can include a field, where the DCI field dynamically indicates the number of repetitions of the PUCCH.

The dynamically signaled number of PUCCH repetitions may depend on UCI type, and/or the physical layer priority of the UCI, where the UCI is carried by the PUCCH. The DCI field size (including 0 bit, i.e., absence of the DCI field) for indicating the number of repetitions of the PUCCH may be configurable by a higher layer parameter.

In another embodiment, an existing DCI field may be used to indicate the number of PUCCH repetitions. For instance, the ‘PUCCH resource indicator’ field in DCI can be used to indicate the number of repetitions for PUCCH. For instance, one codepoint in a PUCCH resource indicator field in DCI may be configured with one number of PUCCH repetitions while another codepoint in the PUCCH resource indicator field in DCI may be associated with another number of PUCCH repetitions. Some codepoints of the PUCCH resource indicator field may be associated with a single PUCCH (i.e., number of PUCCH repetitions is 1). In another embodiment, the PUCCH resource indicator field in DCI may be partitioned into two sub-fields where a first sub-field is used to indicate the number of PUCCH repetitions while the second sub-field is used to indicate the PUCCH resource to be used for PUCCH transmission.

In one embodiment, a repetition number value (the first repetition number value) is configured to be used for UCI feedback for URLLC based traffic (or high physical layer priority) and another (the second repetition number value) for eMBB traffic (or low physical layer priority). While PUCCH can carry various types of UCI content (HARQ-ACK, SR, CSI, or a combination thereof), here PUCCH carrying HARQ-ACK is used as an illustration.

To perform dynamic switching between the first and second repetition number values (which are configured by higher layers), some mechanism is needed to indicate this switching to the UE, since the gNB and the UE must be aligned in the number of repetitions to use for PUCCH. If a PUCCH carries a HARQ-ACK associated with a PDSCH, which is scheduled with one or more of the following criteria, then the first repetition number may be used for PUCCH transmission:
2 TCI states are indicated in the Transmission configuration indication field (if present) of the DCI scheduling the PDSCH;
One of the DL multi-TRP PDSCH schemes (i.e., configured by a higher layer parameter RepetitionSchemeConfig-r16 in 3GPP TS38.331 V16.1.0) is used for an associated PDSCH;
The Priority indicator field (if present) of the scheduling DCI is set to “1” (i.e., high physical layer priority);
The priority level is set to “1” (i.e., high physical layer priority) in RRC parameter of the SPS configuration, where the SPS PDSCH, or SPS release DCI, is associated with the HARQ-ACK carried by the PUCCH;
The PDSCH is scheduled by a designated DCI format, e.g., DCI format 1_2; and
The PUCCH resource is activated with 2 TCI states.

Otherwise, the second repetition number may be used. In yet another embodiment, which repetition number to be used may be dynamically indicated in DCI.

### Handling of Collision between PUCCH and other Uplink Channels, Signals

One or more of the PUCCH repetitions may overlap in time with other uplink channels and/or signals, including another PUCCH, Physical Uplink Shared Channel (PUSCH), Sounding Reference Signal (SRS), Physical Random Access Channel (PRACH). Then multiplexing and/or prioritization procedures apply to resolve the collision. The collision resolution procedure takes into account of the relative physical layer priority of the colliding uplink channels/signals, if different levels of physical layer priority are provided.

In one embodiment, if the UE is scheduled to transmit a PUCCH repetition as well as another overlapping UL channel signal with a same priority to a same TRP (e.g., TRP1), then the UE multiplexes them before transmitting to another TRP (e.g., TRP2). (note here that toward same TRP means the PUCCH and the other UL channel have same spatial relation reference, or use the same unified TCI state or use the same UL TCI state).

In another embodiment, if the UE is scheduled to transmit a PUCCH repetition as well as another overlapping UL channel signal to a same TRP, then the UE selects the channel (or signal) with higher priority to transmit, while dropping the channel (or signal) of lower priority.

In a case that the UE is scheduled to transmit a PUCCH repetition to TRP1 and another overlapping UL channel with lower priority to either TRP1 or TRP2, then the other channel is dropped. If the overlapping UL channel has a higher priority, the PUCCH is dropped.

In another embodiment, if the UE is scheduled to transmit a PUCCH repetition to either TRP1 or TRP2 and another overlapping PUSCH with a same priority to TRP2, then the PUCCH is multiplexed with the PUSCH and transmitted to TRP2. In one embodiment, the uplink multiplexing and prioritization procedure is applied for the procedure of transmission towards each TRP (e.g. each spatial relation) separately and independently.

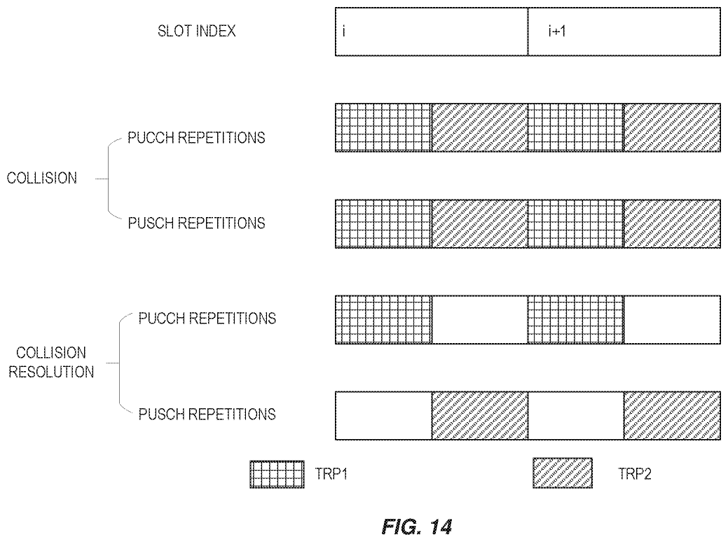

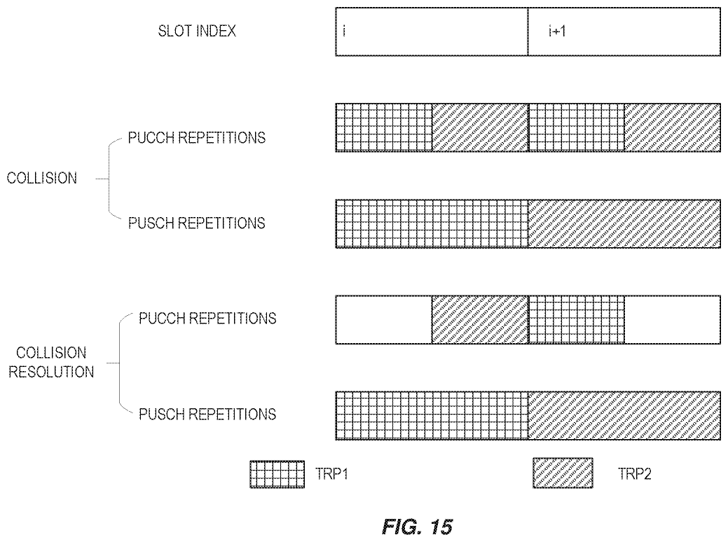

In another embodiment, uplink multiplexing and prioritization procedure considers the transmission to multiple TRP jointly. For example, if a PUCCH (with repetitions) and a PUSCH (with repetitions) overlap on both TRPs (e.g., TRP1 and TRP2), then PUCCH may be selected for transmission towards TRP1 (and PUSCH to TRP1 is dropped), and PUSCH may be selected for transmission towards TRP2 (and PUCCH to TRP2 is dropped). Examples are shown in FIGS. 14 and 15.

In another embodiment, collision of PUCCH with other UL channels/signals are handled separately for each PUCCH repetition (sub-slot-based repetition or slot-based repetition), also separately for each TRP.

### Handling of Symbols Invalid for PUCCH Transmission

For PUCCH repetitions, it may happen that the resource intended for a transmission is an invalid resource. A resource may be an Orthogonal Frequency Division Multiplexing (OFDM) symbol or a resource element in this context.

The UE can determine or identified invalid symbol(s) for PUCCH repetitions due to numerous reasons. In principle, any symbols that cannot be counted as available for uplink transmission are invalid for PUCCH repetitions.

For Multi-TRP PUCCH transmission, while the PUCCH can be transmitted towards multiple TRPs for diversity, there are still scenarios where certain symbols cannot be used for PUCCH transmission. These symbols are called invalid symbols in discussion below. For a given invalid symbol, if it would otherwise have been used for PUCCH transmission for M-TRP #j, then this PUCCH repetition may be dropped or delayed, affecting the overall PUCCH transmission towards M-TRP #j.

In the following, numerous scenarios that cause symbols unavailable for uplink transmission (hence unavailable for PUCCH repetitions) are described for M-TRP. With “M-TRP” means that the UE is configured for uplink transmission where their reception is intended for more than one TRP, i.e., using multiple spatial relations, multiple UL TCI states or multiple unified TCI states.

In one example, a symbol that is indicated as downlink by tdd-UL-DL-ConfigurationCommon or tdd-UL-DL-ConfigurationDedicated is considered as an invalid symbol for PUCCH repetitions.

In another example, for operation in unpaired spectrum, symbols indicated by ssb-PositionsInBurst in System Information Block #1 (SIB1) or ssb-PositionsInBurst in ServingCellConfigCommon for reception of Synchronization Signal (SS)/Physical Broadcast Channel (PBCH) blocks are considered as invalid symbols for PUCCH repetitions.

In another example, for operation in unpaired spectrum, symbol(s) indicated by pdcch-ConfigSIB1 in MIB for a CORESET for TypeO-PDCCH CSS set are considered as invalid symbol(s) for PUCCH repetitions.

In another example, for operation in unpaired spectrum, if numberInvalidSymbolsForDL-UL-Switching is configured, numberInvalidSymbolsForDL-UL-Switching symbol(s) after the last symbol that is indicated as downlink in each consecutive set of all symbols that are indicated as downlink by tdd-UL-DL-ConfigurationCommon or tdd-UL-DL-ConfigurationDedicated are considered as invalid symbol(s) for PUCCH repetitions. The symbol(s) given by numberInvalidSymbolsForDL-UL-Switching are defined using the reference SCS configuration referenceSubcarrierSpacing provided in tdd-UL-DL-ConfigurationCommon.

In another example, if the UE
is configured with multiple serving cells and is configured to operate with half duplex (for example, half-duplex-behavior-r16=‘enable’), and
is not capable of simultaneous transmission and reception on any of the multiple serving cells, and
indicates support of capability for half-duplex operation in Carrier Aggregation (CA) with unpaired spectrum, and
is not configured to monitor Physical Downlink Control Channel (PDCCH) for detection of DCI format 2-0 on any of the multiple serving cells, then: a symbol is considered as an invalid symbol in any of the multiple serving cells for PUCCH repetitions if the symbol is indicated to the UE for reception of SS/PBCH blocks in any of the multiple serving cells by ssb-PositionsInBurst in SIB1 or ssb-PositionslnBurst in ServingCellConfigCommon.

In another example, a symbol is considered as an invalid symbol in any of the multiple serving cells for PUCCH repetitions if the UE is configured by higher layers to receive PDCCH, PDSCH, or CSI-RS on the reference cell in the symbol.

In another example, a symbol on a shared spectrum is considered as invalid if the UE has not obtained access to the channel, when required.

In another example, a symbol on a shared spectrum is considered as invalid if the symbol overlaps with the idle period corresponding to semi-static channel access procedure.

If a PUCCH repetition overlaps with any invalid symbols, then the overlapping PUCCH repetition cannot be transmitted as is.
In one method, the PUCCH repetition overlapping with invalid symbol(s) is discarded. The remaining PUCCH repetitions are kept for potential transmission. The mapping between TRP and each PUCCH transmission occasion is according to the nominal PUCCH transmission occasions. For example, if 4 PUCCH repetitions are to be transmitted at time [t1 t2 t3 t4] and the associated TRP indices are [1 2 1 2], and if an invalid symbol occurs at t2, then PUCCH transmission at t2 will be dropped and the actual PUCCH transmissions will occur at [t1 t3 t4]. The associated TRP indices would be [1 1 2].
In another method, the PUCCH repetition overlapping with invalid symbol(s) is delayed till the PUCCH repetition can be transmitted with at least n consecutive valid symbols within a slot. Here n is the duration of one PUCCH repetition counted in number of symbols. Subsequent PUCCH repetitions are delayed as well. In one variation, all PUCCH repetitions are transmitted, though delayed due to invalid symbols. In another variation, PUCCH repetitions are delayed and transmitted till a timing limit is reached.

### Timing Impact of PUCCH Repetition

When PUCCH repetition is configured or indicated via DCI to be sent over multiple slots, the reference to PUCCH transmission slots shall be referring to the last slot of PUCCH repetition. For Media Access Control (MAC) Control element (CE) based activation command, e.g., for beam switch (i.e., TCI state update)), being received in PDSCH, the time at which the UE applies the command, e.g., the TCI state provided in the activation command, is based on the last slot among the multiple slots in which PUCCH is repeated.

For example, if PUCCH repetition is configured by higher layers or indicated via DCI to carry HARQ-ACK, and the UE receives a MAC CE command activating a TCI state, the UE shall apply the command according to the timing described below:
After UE receives a MAC CE activation command for one of the TCI states, the UE applies the activation command in the first slot that is after slot k+3Nₛₗₒₜ^{subframe,μ}, where k is the last slot where the UE would transmit a PUCCH with HARQ-ACK information with ACK for the PDSCH providing the activation command and p is the SCS configuration for the PUCCH. The active BWP is defined as the active BWP in the slot when the activation command is applied.

In another example, if PUCCH repetition is used to carry HARQ ACK, and when a UE receives a MAC CE command to activating a SRS resource, the UE shall apply the command according to the timing described below:
The UE applies corresponding actions in 38.321 and a corresponding setting for a spatial domain filter to transmit PUCCH in the first slot that is after slot k+3Nₛₗₒₜ^{subframe,μ}, where k is the last slot where the UE would transmit a PUCCH with HARQ-ACK information with ACK value corresponding to a PDSCH reception providing the PUCCH-Spatia/RelationInfo and μ is the SCS configuration for the PUCCH.

Similarly, in another embodiment, when PUCCH repetition is configured by higher layers or indicated via DCI, the time at which the UE applies the PDSCH RE mapping corresponding to the activated Zero Power (ZP) CSI-RS resource(s) provided by the ‘SP ZP CSI-RS Resource Set Activation/Deactivation MAC CE’ activation command in TS38.321 is based on the last slot among multiple slots in which PUCCH is repeated. The following is an example of how to capture this embodiment in 3GPP specifications:
For a UE configured with a list of ZP-CSI-RS-ResourceSet(s) provided by higher layer parameter sp-ZP-CSI-RS-ResourceSetsToAddModList:
   when the UE would transmit a PUCCH with HARQ-ACK information in slot n where n is the last slot where the UE would transmit a PUCCH with HARQ-ACK information corresponding to the PDSCH carrying the activation command, as described in clause 6.1.3.19 of [10, TS 38.321], for ZP CSI-RS resource(s), the corresponding action in [10, TS 38.321] and the UE assumption on the PDSCH RE mapping corresponding to the activated ZP CSI-RS resource(s) shall be applied starting from the first slot that is after slot n+3Nₛₗₒₜ^{subframe,μ} where μ is the SCS configuration for the PUCCH.
   when the UE would transmit a PUCCH with HARQ-ACK information in slot n where n is the last slot where the UE would transmit a PUCCH with HARQ-ACK information corresponding to the PDSCH carrying the deactivation command, as described in clause 6.1.3.19 of [10, TS 38.321], for activated ZP CSI-RS resource(s), the corresponding action in [10, TS 38.321] and the UE assumption on cessation of the PDSCH RE mapping corresponding to the de-activated ZP CSI-RS resource(s) shall be applied starting from the first slot that is after slot n+3Nₛₗₒₜ^{subframe,μ} where μ is the SCS configuration for the PUCCH.

Although the above embodiment is written with respect to ‘SP ZP CSI-RS Resource Set Activation/Deactivation MAC CE’ activation command, the embodiment can also be extended to the cases of the following MAC CE activation commands in TS 38.321:
Enhanced TCI States Activation/Deactivation for UE-specific PDSCH MAC CE;
SP CSI reporting on PUCCH Activation/Deactivation MAC CE;
SP CSI-RS/CSI-IM Resource Set Activation/Deactivation MAC CE;
SP SRS Activation/Deactivation MAC CE;
SP Positioning SRS Activation/Deactivation MAC CE; and
Enhanced SP/AP SRS Spatial Relation Indication MAC CE.

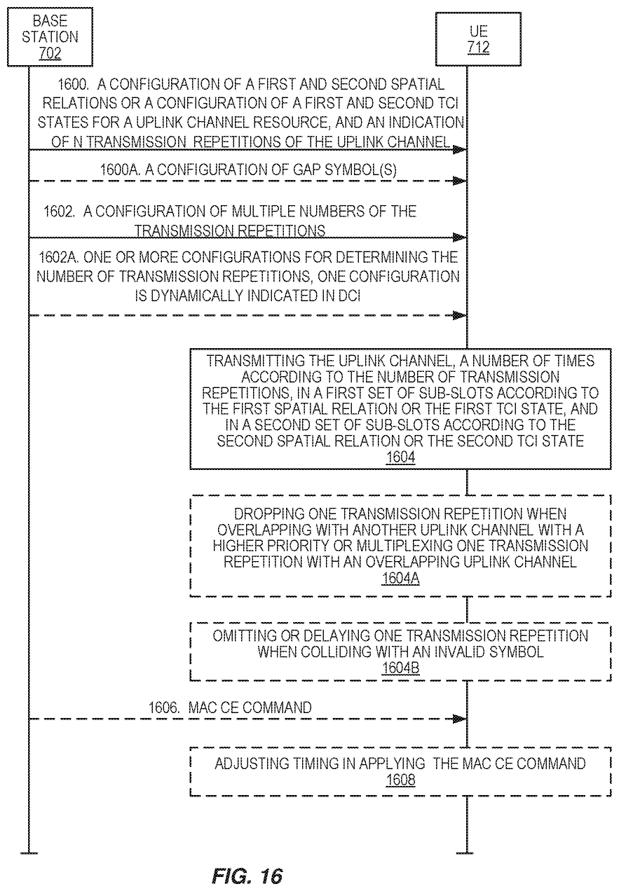

FIG. 16 illustrates the operation of a UE 712 and a base station 702 in accordance with at least some of the embodiments described above. Note that optional steps are represented by dashed lines/boxes. As illustrated, the base station 702 provides and the UE 712 receives a first configuration of a first relation and a second spatial relation for an uplink channel, and an indication of a number of transmission occasions/repetitions (step 1600). The uplink channel may be a PUCCH and more particular, may be one of PUCCH formats 0 to 4. As discussed above, the UE 712 may also receive, from the base station 702, a configuration of a gap symbol between adjacent transmission occasions/repetitions (step 1600A).

In addition, the base station 702 may also provide and the UE 712 may also receive a second configuration of multiple numbers of the transmission repetitions for the uplink channel (step 1602), wherein which repetition number to use depends on whether one or more of the following conditions are met:
a. 2 TCI states are indicated in the Transmission configuration indication field (if present) of the DCI scheduling the PDSCH
b. One of the DL multi-TRP PDSCH schemes (i.e., configured by a higher layer parameter RepetitionSchemeConfig-r16) is used for an associated PDSCH
c. The Priority indicator field (if present) of the DCI is set to “1”
d. The PDSCH is scheduled by DCI format 1_2
e. The PUCCH resource is activated with 2 TCI states
f. Certain UCI type carried by the PUCCH

As discussed above, in one embodiment, the repetition number to use for the uplink channel may also depend on a traffic type that the uplink channel is associated with.

As discussed above, in one embodiment, the UE 712 may also receive, from the base station 702, one or more configurations for determining the number of transmission repetitions, where the one of the one or more configurations are dynamically indicated in downlink control information, DCI (step 1602A).

The UE 712 then transmits the uplink channel, a number of times according to the number of transmission repetitions, in a first set of sub-slots according to the first spatial relation, and in a second set of sub-slots according to the second spatial relation (step 1604). The total number of sub-slots in the first set and the second set of sub-slots equals to the number of repetitions, where each sub-lot includes a number of OFDM symbols. In one embodiment, the first set and the second set of sub-slots are non-overlapping in time. In one embodiment, the first set and the second set of sub-slots are in a same slot. In one embodiment, the first set and the second set of sub-slots are either explicitly or implicitly configured. In one embodiment, time and frequency resource allocations in each sub-slot of the first set and the second set of sub-slots are the same (i.e., with a relative same starting symbol within a sub-slot, a same number of symbols and same resource blocks).

As discussed above, in one embodiment, the UE 712 may drop one transmission repetition when it is overlapping with another UL channel with a higher priority (step 1604A).

As discussed above, in one embodiment, the UE 712 may multiplex one transmission repetition with an overlapping UL channel with a same priority (step 1604A).

As discussed above, in one embodiment, the UE 712 may omit a corresponding transmission occasion if the UE 712 collides with an invalid symbol or may delay the corresponding transmission occasion until enough valid symbols are available (step 1604B).

As discussed above, in one embodiment, the UE 712 may receive a MAC CE command from the base station 702 (step 1606). And then, the UE 712 may adjust timing in applying the MAC CE command according to the slot or sub-slot over which the last PUCCH transmission carrying a corresponding HARQ-ACK associated with the MAC CE command is transmitted (step 1608).

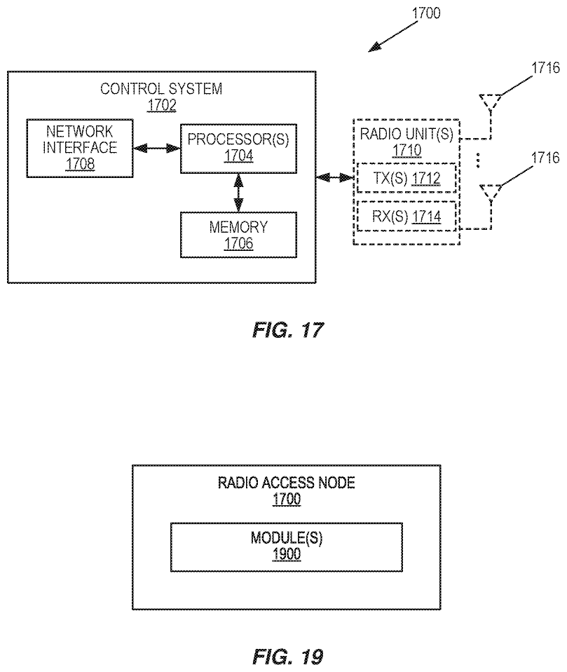

FIG. 17 is a schematic block diagram of a radio access node 1700 according to some embodiments of the present disclosure. Optional features are represented by dashed boxes. The radio access node 1700 may be, for example, a base station 702 or 706 or a network node that implements all or part of the functionality of the base station 702 or gNB described herein. As illustrated, the radio access node 1700 includes a control system 1702 that includes one or more processors 1704 (e.g., Central Processing Units (CPUs), Application Specific Integrated Circuits (ASICs), Field Programmable Gate Arrays (FPGAs), and/or the like), memory 1706, and a network interface 1708. The one or more processors 1704 are also referred to herein as processing circuitry. In addition, the radio access node 1700 may include one or more radio units 1710 that each includes one or more transmitters 1712 and one or more receivers 1714 coupled to one or more antennas 1716. The radio units 1710 may be referred to or be part of radio interface circuitry. In some embodiments, the radio unit(s) 1710 is external to the control system 1702 and connected to the control system 1702 via, e.g., a wired connection (e.g., an optical cable). However, in some other embodiments, the radio unit(s) 1710 and potentially the antenna(s) 1716 are integrated together with the control system 1702. The one or more processors 1704 operate to provide one or more functions of a radio access node 1700 as described herein. In some embodiments, the function(s) are implemented in software that is stored, e.g., in the memory 1706 and executed by the one or more processors 1704.

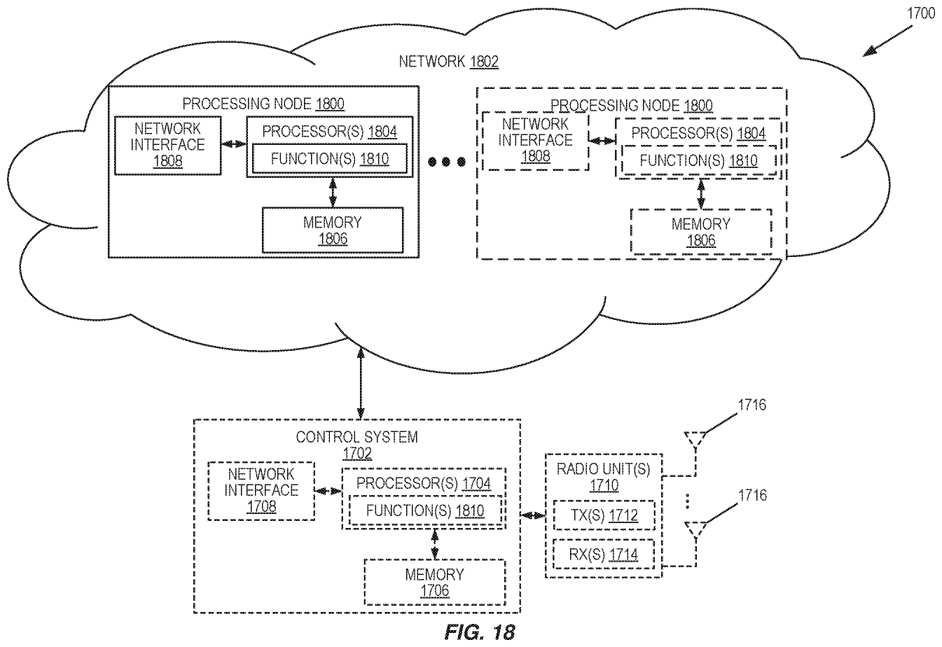

FIG. 18 is a schematic block diagram that illustrates a virtualized embodiment of the radio access node 1700 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1700 in which at least a portion of the functionality of the radio access node 1700 is implemented as a virtual component(s) (e.g., via a virtual machine(s) executing on a physical processing node(s) in a network(s)). As illustrated, in this example, the radio access node 1700 may include the control system 1702 and/or the one or more radio units 1710, as described above. The control system 1702 may be connected to the radio unit(s) 1710 via, for example, an optical cable or the like. The radio access node 1700 includes one or more processing nodes 1800 coupled to or included as part of a network(s) 1802. If present, the control system 1702 or the radio unit(s) are connected to the processing node(s) 1800 via the network 1802. Each processing node 1800 includes one or more processors 1804 (e.g., CPUs, ASICs, FPGAs, and/or the like), memory 1806, and a network interface 1808.

In this example, functions 1810 of the radio access node 1700 described herein are implemented at the one or more processing nodes 1800 or distributed across the one or more processing nodes 1800 and the control system 1702 and/or the radio unit(s) 1710 in any desired manner. In some particular embodiments, some or all of the functions 1810 of the radio access node 1700 described herein are implemented as virtual components executed by one or more virtual machines implemented in a virtual environment(s) hosted by the processing node(s) 1800. As will be appreciated by one of ordinary skill in the art, additional signaling or communication between the processing node(s) 1800 and the control system 1702 is used in order to carry out at least some of the desired functions 1810. Notably, in some embodiments, the control system 1702 may not be included, in which case the radio unit(s) 1710 communicates directly with the processing node(s) 1800 via an appropriate network interface(s).

In some embodiments, a computer program including instructions which, when executed by at least one processor, causes the at least one processor to carry out the functionality of radio access node 1700 or a node (e.g., a processing node 1800) implementing one or more of the functions 1810 of the radio access node 1700 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 19 is a schematic block diagram of the radio access node 1700 according to some other embodiments of the present disclosure. The radio access node 1700 includes one or more modules 1900, each of which is implemented in software. The module(s) 1900 provide the functionality of the radio access node 1700 described herein. This discussion is equally applicable to the processing node 1800 of FIG. 18 where the modules 1900 may be implemented at one of the processing nodes 1800 or distributed across multiple processing nodes 1800 and/or distributed across the processing node(s) 1800 and the control system 1702.

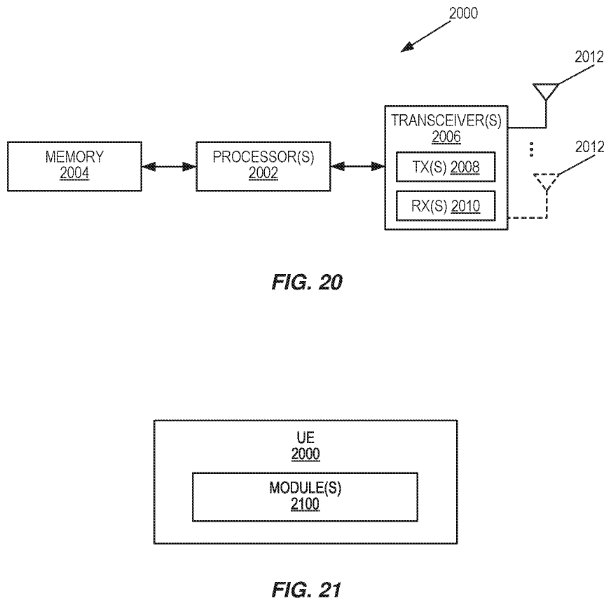

FIG. 20 is a schematic block diagram of a wireless communication device 2000 according to some embodiments of the present disclosure. The wireless communication device 2000 may be, for example, the UE 712 described herein. As illustrated, the wireless communication device 2000 includes one or more processors 2002 (e.g., CPUs, ASICs, FPGAs, and/or the like), memory 2004, and one or more transceivers 2006 each including one or more transmitters 2008 and one or more receivers 2010 coupled to one or more antennas 2012. The transceiver(s) 2006 includes radio-front end circuitry connected to the antenna(s) 2012 that is configured to condition signals communicated between the antenna(s) 2012 and the processor(s) 2002, as will be appreciated by on of ordinary skill in the art. The processors 2002 are also referred to herein as processing circuitry. The transceivers 2006 are also referred to herein as radio circuitry. In some embodiments, the functionality of the wireless communication device 2000 described above may be fully or partially implemented in software that is, e.g., stored in the memory 2004 and executed by the processor(s) 2002. Note that the wireless communication device 2000 may include additional components not illustrated in FIG. 20 such as, e.g., one or more user interface components (e.g., an input/output interface including a display, buttons, a touch screen, a microphone, a speaker(s), and/or the like and/or any other components for allowing input of information into the wireless communication device 2000 and/or allowing output of information from the wireless communication device 2000), a power supply (e.g., a battery and associated power circuitry), etc.

In some embodiments, a computer program including instructions which, when executed by at least one processor, causes the at least one processor to carry out the functionality of the wireless communication device 2000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 21 is a schematic block diagram of the wireless communication device 2000 according to some other embodiments of the present disclosure. The wireless communication device 2000 includes one or more modules 2100, each of which is implemented in software. The module(s) 2100 provide the functionality of the wireless communication device 2000 described herein.

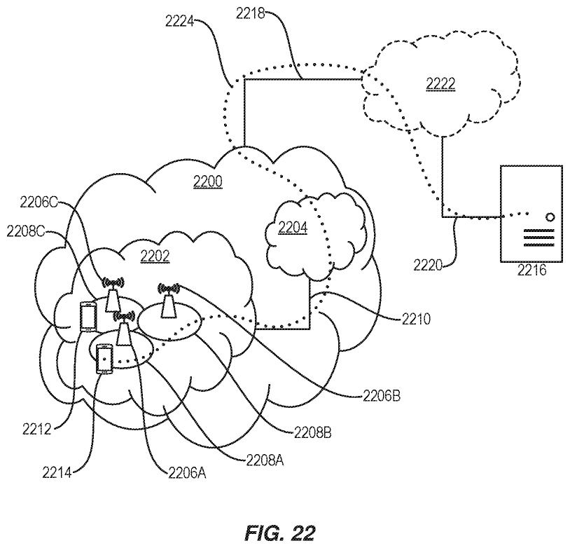

With reference to FIG. 22, in accordance with an embodiment, a communication system includes a telecommunication network 2200, such as a 3GPP-type cellular network, which comprises an access network 2202, such as a RAN, and a core network 2204. The access network 2202 comprises a plurality of base stations 2206A, 2206B, 2206C, such as Node Bs, eNBs, gNBs, or other types of wireless Access Points (APs), each defining a corresponding coverage area 2208A, 2208B, 2208C. Each base station 2206A, 2206B, 2206C is connectable to the core network 2204 over a wired or wireless connection 2210. A first UE 2212 located in coverage area 2208C is configured to wirelessly connect to, or be paged by, the corresponding base station 2206C. A second UE 2214 in coverage area 2208A is wirelessly connectable to the corresponding base station 2206A. While a plurality of UEs 2212, 2214 are illustrated in this example, the disclosed embodiments are equally applicable to a situation where a sole UE is in the coverage area or where a sole UE is connecting to the corresponding base station 2206.

The telecommunication network 2200 is itself connected to a host computer 2216, which may be embodied in the hardware and/or software of a standalone server, a cloud-implemented server, a distributed server, or as processing resources in a server farm. The host computer 2216 may be under the ownership or control of a service provider, or may be operated by the service provider or on behalf of the service provider. Connections 2218 and 2220 between the telecommunication network 2200 and the host computer 2216 may extend directly from the core network 2204 to the host computer 2216 or may go via an optional intermediate network 2222. The intermediate network 2222 may be one of, or a combination of more than one of, a public, private, or hosted network; the intermediate network 2222, if any, may be a backbone network or the Internet; in particular, the intermediate network 2222 may comprise two or more sub-networks (not shown).

The communication system of FIG. 22 as a whole enables connectivity between the connected UEs 2212, 2214 and the host computer 2216. The connectivity may be described as an Over-the-Top (OTT) connection 2224. The host computer 2216 and the connected UEs 2212, 2214 are configured to communicate data and/or signaling via the OTT connection 2224, using the access network 2202, the core network 2204, any intermediate network 2222, and possible further infrastructure (not shown) as intermediaries. The OTT connection 2224 may be transparent in the sense that the participating communication devices through which the OTT connection 2224 passes are unaware of routing of uplink and downlink communications. For example, the base station 2206 may not or need not be informed about the past routing of an incoming downlink communication with data originating from the host computer 2216 to be forwarded (e.g., handed over) to a connected UE 2212. Similarly, the base station 2206 need not be aware of the future routing of an outgoing uplink communication originating from the UE 2212 towards the host computer 2216.

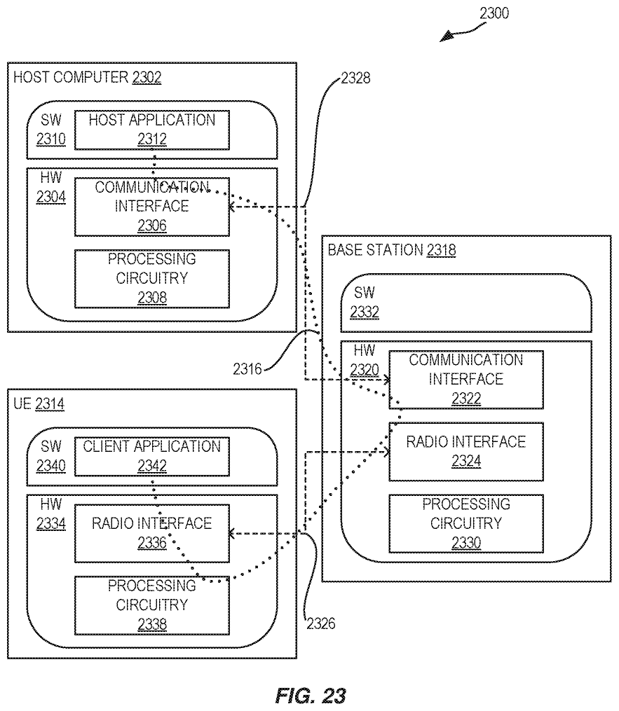

Example implementations, in accordance with an embodiment, of the UE, base station, and host computer discussed in the preceding paragraphs will now be described with reference to FIG. 23. In a communication system 2300, a host computer 2302 comprises hardware 2304 including a communication interface 2306 configured to set up and maintain a wired or wireless connection with an interface of a different communication device of the communication system 2300. The host computer 2302 further comprises processing circuitry 2308, which may have storage and/or processing capabilities. In particular, the processing circuitry 2308 may comprise one or more programmable processors, ASICs, FPGAs, or combinations of these (not shown) adapted to execute instructions. The host computer 2302 further comprises software 2310, which is stored in or accessible by the host computer 2302 and executable by the processing circuitry 2308. The software 2310 includes a host application 2312. The host application 2312 may be operable to provide a service to a remote user, such as a UE 2314 connecting via an OTT connection 2316 terminating at the UE 2314 and the host computer 2302. In providing the service to the remote user, the host application 2312 may provide user data which is transmitted using the OTT connection 2316.

The communication system 2300 further includes a base station 2318 provided in a telecommunication system and comprising hardware 2320 enabling it to communicate with the host computer 2302 and with the UE 2314. The hardware 2320 may include a communication interface 2322 for setting up and maintaining a wired or wireless connection with an interface of a different communication device of the communication system 2300, as well as a radio interface 2324 for setting up and maintaining at least a wireless connection 2326 with the UE 2314 located in a coverage area (not shown in FIG. 23) served by the base station 2318. The communication interface 2322 may be configured to facilitate a connection 2328 to the host computer 2302. The connection 2328 may be direct or it may pass through a core network (not shown in FIG. 23) of the telecommunication system and/or through one or more intermediate networks outside the telecommunication system. In the embodiment shown, the hardware 2320 of the base station 2318 further includes processing circuitry 2330, which may comprise one or more programmable processors, ASICs, FPGAs, or combinations of these (not shown) adapted to execute instructions. The base station 2318 further has software 2332 stored internally or accessible via an external connection.

The communication system 2300 further includes the UE 2314 already referred to. The UE's 2314 hardware 2334 may include a radio interface 2336 configured to set up and maintain a wireless connection 2326 with a base station serving a coverage area in which the UE 2314 is currently located. The hardware 2334 of the UE 2314 further includes processing circuitry 2338, which may comprise one or more programmable processors, ASICs, FPGAs, or combinations of these (not shown) adapted to execute instructions. The UE 2314 further comprises software 2340, which is stored in or accessible by the UE 2314 and executable by the processing circuitry 2338. The software 2340 includes a client application 2342. The client application 2342 may be operable to provide a service to a human or non-human user via the UE 2314, with the support of the host computer 2302. In the host computer 2302, the executing host application 2312 may communicate with the executing client application 2342 via the OTT connection 2316 terminating at the UE 2314 and the host computer 2302. In providing the service to the user, the client application 2342 may receive request data from the host application 2312 and provide user data in response to the request data. The OTT connection 2316 may transfer both the request data and the user data. The client application 2342 may interact with the user to generate the user data that it provides.

It is noted that the host computer 2302, the base station 2318, and the UE 2314 illustrated in FIG. 23 may be similar or identical to the host computer 2216, one of the base stations 2206A, 2206B, 2206C, and one of the UEs 2212, 2214 of FIG. 22, respectively. This is to say, the inner workings of these entities may be as shown in FIG. 23 and independently, the surrounding network topology may be that of FIG. 22.

In FIG. 23, the OTT connection 2316 has been drawn abstractly to illustrate the communication between the host computer 2302 and the UE 2314 via the base station 2318 without explicit reference to any intermediary devices and the precise routing of messages via these devices. The network infrastructure may determine the routing, which may be configured to hide from the UE 2314 or from the service provider operating the host computer 2302, or both. While the OTT connection 2316 is active, the network infrastructure may further take decisions by which it dynamically changes the routing (e.g., on the basis of load balancing consideration or reconfiguration of the network).

The wireless connection 2326 between the UE 2314 and the base station 2318 is in accordance with the teachings of the embodiments described throughout this disclosure. One or more of the various embodiments improve the performance of OTT services provided to the UE 2314 using the OTT connection 2316, in which the wireless connection 2326 forms the last segment. More precisely, the teachings of these embodiments may improve the utilization of PUCCH, and thereby provide benefits such as enhancing reliability of the PUCCH, keeping the latency low, and/or saving UE power consumption.

A measurement procedure may be provided for the purpose of monitoring data rate, latency, and other factors on which the one or more embodiments improve. There may further be an optional network functionality for reconfiguring the OTT connection 2316 between the host computer 2302 and the UE 2314, in response to variations in the measurement results. The measurement procedure and/or the network functionality for reconfiguring the OTT connection 2316 may be implemented in the software 2310 and the hardware 2304 of the host computer 2302 or in the software 2340 and the hardware 2334 of the UE 2314, or both. In some embodiments, sensors (not shown) may be deployed in or in association with communication devices through which the OTT connection 2316 passes; the sensors may participate in the measurement procedure by supplying values of the monitored quantities exemplified above, or supplying values of other physical quantities from which the software 2310, 2340 may compute or estimate the monitored quantities. The reconfiguring of the OTT connection 2316 may include message format, retransmission settings, preferred routing, etc.; the reconfiguring need not affect the base station 2318, and it may be unknown or imperceptible to the base station 2318. Such procedures and functionalities may be known and practiced in the art. In certain embodiments, measurements may involve proprietary UE signaling facilitating the host computer 2302's measurements of throughput, propagation times, latency, and the like. The measurements may be implemented in that the software 2310 and 2340 causes messages to be transmitted, in particular empty or ‘dummy’ messages, using the OTT connection 2316 while it monitors propagation times, errors, etc.

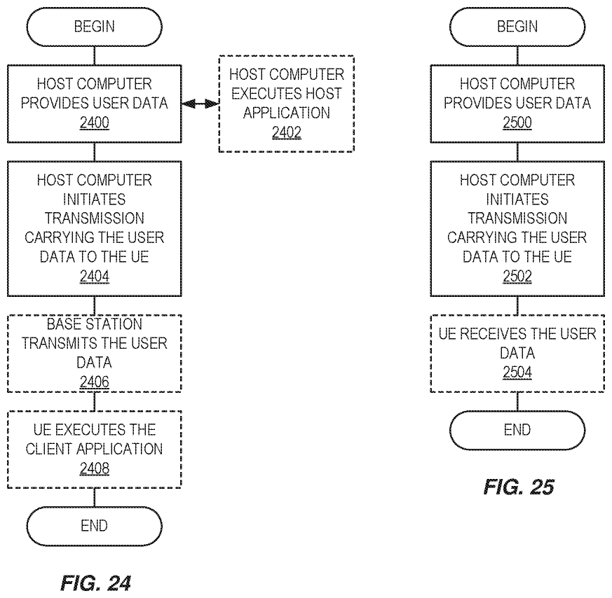

FIG. 24 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 24 will be included in this section. In step 2400, the host computer provides user data. In sub-step 2402 (which may be optional) of step 2400, the host computer provides the user data by executing a host application. In step 2404, the host computer initiates a transmission carrying the user data to the UE. In step 2406 (which may be optional), the base station transmits to the UE the user data which was carried in the transmission that the host computer initiated, in accordance with the teachings of the embodiments described throughout this disclosure. In step 2408 (which may also be optional), the UE executes a client application associated with the host application executed by the host computer.

FIG. 25 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 25 will be included in this section. In step 2500 of the method, the host computer provides user data. In an optional sub-step (not shown) the host computer provides the user data by executing a host application. In step 2502, the host computer initiates a transmission carrying the user data to the UE. The transmission may pass via the base station, in accordance with the teachings of the embodiments described throughout this disclosure. In step 2504 (which may be optional), the UE receives the user data carried in the transmission.

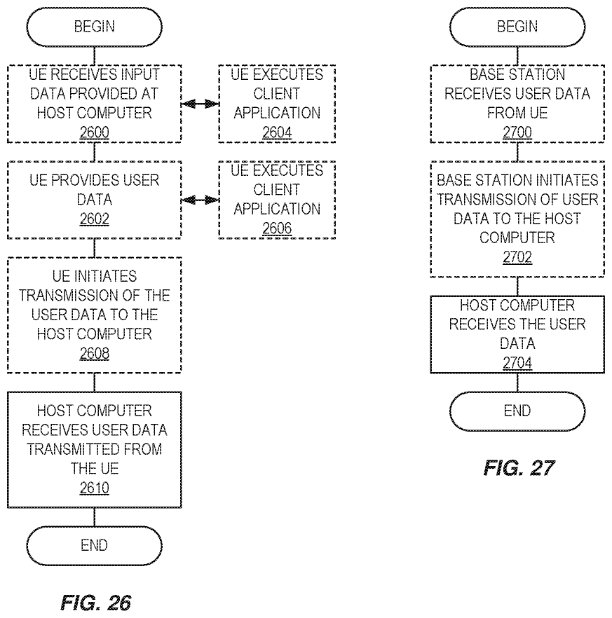

FIG. 26 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 26 will be included in this section. In step 2600 (which may be optional), the UE receives input data provided by the host computer. Additionally or alternatively, in step 2602, the UE provides user data. In sub-step 2604 (which may be optional) of step 2600, the UE provides the user data by executing a client application. In sub-step 2606 (which may be optional) of step 2602, the UE executes a client application which provides the user data in reaction to the received input data provided by the host computer. In providing the user data, the executed client application may further consider user input received from the user. Regardless of the specific manner in which the user data was provided, the UE initiates, in sub-step 2608 (which may be optional), transmission of the user data to the host computer. In step 2610 of the method, the host computer receives the user data transmitted from the UE, in accordance with the teachings of the embodiments described throughout this disclosure.

FIG. 27 is a flowchart illustrating a method implemented in a communication system, in accordance with one embodiment. The communication system includes a host computer, a base station, and a UE which may be those described with reference to FIGS. 22 and 23. For simplicity of the present disclosure, only drawing references to FIG. 27 will be included in this section. In step 2700 (which may be optional), in accordance with the teachings of the embodiments described throughout this disclosure, the base station receives user data from the UE. In step 2702 (which may be optional), the base station initiates transmission of the received user data to the host computer. In step 2704 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method of uplink transmission, performed by a user equipment, UE, (712) in a wireless communication network that includes two or more transmission and receiving points, TRPs, each associated with a spatial relation or a TCI state, the method comprising:
receiving (1600), from a base station (702) in the wireless communication network, a configuration of a first spatial relation and a second spatial relation for a uplink channel, and an indication of a number of transmission repetitions of the uplink channel; and
transmitting (1604) the uplink channel, a number of times according to the number of transmission repetitions, in a first set of sub-slots according to the first spatial relation, and in a second set of sub-slots according to the second spatial relation.

Embodiment 2: The method of embodiment 1 wherein the uplink channel is a physical uplink control channel, PUCCH.

Embodiment 3: The method of embodiment 1 or 2, wherein a total number of sub-slots in the first set of sub-slots and the second set of sub-slots equal to the number of transmission repetitions.

Embodiment 4: The method of any one of embodiments 1 to 3, wherein each sub-slot in a slot, which comprises the first set of sub-slots and the second set of sub-slots, comprises a number of OFDM symbols.

Embodiment 5: The method of any one of embodiments 1 to 4, wherein the first set of sub-slots and the second set of sub-slots are non-overlapping in time.

Embodiment 6: The method of any one of embodiments 1 to 5, wherein the first set of sub-slots and the second set of sub-slots are in a same slot.

Embodiment 7: The method of any one of embodiments 1 to 6, wherein time and frequency resource allocations in each sub-slot of the first set of sub-slots and the second set of sub-slots have a same pattern.

Embodiment 8: The method of any one of embodiments 1 to 7, wherein the uplink channel is one of PUCCH formats 0 to 4.

Embodiment 9: The method of any one of embodiments 1 to 8 further comprising receiving (1600A), from the base station (702), another configuration of a gap symbol between adjacent transmission repetitions.

Embodiment 10: The method of any one of embodiments 1 to 9 further comprising:
receiving (1602), from the base station (702), a second configuration of multiple numbers of the transmission repetitions for the uplink channel, wherein which repetition number to use depends on whether one or more of the following conditions are met:
   2 TCI states are indicated in the Transmission configuration indication field (if present) of the DCI scheduling the PDSCH;
   One of the DL multi-TRP PDSCH schemes (i.e., configured by a higher layer parameter RepetitionSchemeConfig-r16) is used for an associated PDSCH;
   The Priority indicator field (if present) of the DCI is set to “1”;
   The PDSCH is scheduled by DCI format 1_2;
   The PUCCH resource is activated with 2 TCI states; and
   Certain UCI type carried by the PUCCH.

Embodiment 11: The method of any one of embodiments 1 to 9 further comprising:
receiving (1602), from the base station (702), a second configuration of multiple numbers of the transmission repetitions for the uplink channel, wherein which repetition number to use depends on a traffic type that the uplink channel is associated with.

Embodiment 12: The method of any one of embodiments 1 to 9 further comprising receiving (1602A), from the base station (702), one or more configurations for determining the number of transmission repetitions, wherein one of the one or more configurations is dynamically indicated in downlink control information, DCI.

Embodiment 13: The method of any one of embodiments 1 to 12 further comprising dropping (1604A) one transmission repetition when it is overlapping with another uplink channel with a higher priority.

Embodiment 14: The method of any one of embodiments 1 to 12 further comprising multiplexing (1604A) one transmission repetition with an overlapping uplink channel with a same priority.

Embodiment 15: The method of any one of embodiments 1 to 12 further comprising omitting a corresponding transmission repetition if the UE (712) collides with an invalid symbol.

Embodiment 16: The method of any one of embodiments 1 to 12 further comprising, if the UE (712) collides with an invalid symbol, delaying a corresponding transmission repetition until enough valid symbols are available (step 1604B).

Embodiment 17: The method of any one of embodiments 1 to 16 further comprising receiving (1606) a Media Access Control (MAC) control element (CE) command from the base station (702).

Embodiment 18: The method of embodiment 17 further comprising adjusting (1608) timing in applying the MAC CE command according to the slot or sub-slot over which the last transmission repetition carrying a corresponding HARQ-ACK associated with the MAC CE command is transmitted.

### Group B Embodiments

Embodiment 19: A method of uplink transmission, performed by a base station (702), in a wireless communication network that includes two or more transmission and receiving points, TRPs, each associated with a spatial relation or TCI state, the method comprising: providing (1600), to a user equipment, UE, (712) in the wireless communication network, a configuration of a first spatial relation and a second spatial relation for a uplink channel, and an indication of a number of transmission repetitions in the uplink channel.

Embodiment 20: The method of embodiment 19 wherein the uplink channel is a physical uplink control channel, PUCCH.

Embodiment 21: The method of embodiment 19 or 20 further comprising providing (1600A), to the UE (712), another configuration of a gap symbol between adjacent transmission repetitions.

Embodiment 22: The method of any one of embodiments 19 to 21 further comprising providing (1602), to the UE (712), a second configuration of multiple numbers of the transmission repetitions for the uplink channel, wherein which repetition number to use depends on whether one or more of the following conditions are met:
2 TCI states are indicated in the Transmission configuration indication field (if present) of the DCI scheduling the PDSCH;
One of the DL multi-TRP PDSCH schemes (i.e., configured by a higher layer parameter RepetitionSchemeConfig-r16) is used for an associated PDSCH;
The Priority indicator field (if present) of the DCI is set to “1”;
The PDSCH is scheduled by DCI format 1_2;
The PUCCH resource is activated with 2 TCI states; and
Certain UCI type carried by the PUCCH.

Embodiment 23: The method of any one of embodiments 19 to 21 further comprising providing (1602), to the UE (712), a second configuration of multiple numbers of the transmission repetitions for the uplink channel, wherein which repetition number to use depends on a traffic type that the uplink channel is associated with.

Embodiment 24: The method of any one of embodiments 19 to 21 further comprising providing (1602A), to the UE (712), one or more configurations for determining the number of transmission repetitions, wherein one of the one or more configurations is dynamically indicated in downlink control information, DCI.

Embodiment 25: The method of any one of embodiments 19 to 24 further comprising providing (1606), to the UE (712), a Media Access Control (MAC) control element (CE) command.

### Group C Embodiments

Embodiment 26: A wireless device for uplink transmission in a wireless communication network that includes two or more transmission and receiving points, TRPs, each associated with a spatial relation or TCI state, the wireless device comprising:
processing circuitry configured to perform any of the steps of any of the Group A embodiments; and
power supply circuitry configured to supply power to the wireless device.

Embodiment 27: A base station for uplink transmission in a wireless communication network that includes two or more transmission and receiving points, TRPs, each associated with a spatial relation or TCI state, the base station comprising:
processing circuitry configured to perform any of the steps of any of the Group B embodiments; and
power supply circuitry configured to supply power to the base station.

Embodiment 28: A User Equipment, UE, for uplink transmission in a wireless communication network that includes two or more transmission and receiving points, TRPs, each associated with a spatial relation or TCI state comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 29: A communication system including a host computer comprising:
processing circuitry configured to provide user data; and
a communication interface configured to forward the user data to a cellular network for transmission to a User Equipment, UE;
wherein the cellular network comprises a base station having a radio interface and processing circuitry, the base station's processing circuitry configured to perform any of the steps of any of the Group B embodiments.

Embodiment 30: The communication system of the previous embodiment further including the base station.

Embodiment 31: The communication system of the previous 2 embodiments, further including the UE, wherein the UE is configured to communicate with the base station.

Embodiment 32: The communication system of the previous 3 embodiments, wherein:
the processing circuitry of the host computer is configured to execute a host application, thereby providing the user data; and
the UE comprises processing circuitry configured to execute a client application associated with the host application.

Embodiment 33: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the base station performs any of the steps of any of the Group B embodiments.

Embodiment 34: The method of the previous embodiment, further comprising, at the base station, transmitting the user data.

Embodiment 35: The method of the previous 2 embodiments, wherein the user data is provided at the host computer by executing a host application, the method further comprising, at the UE, executing a client application associated with the host application.

Embodiment 36: A User Equipment, UE, configured to communicate with a base station, the UE comprising a radio interface and processing circuitry configured to perform the method of the previous 3 embodiments.

Embodiment 37: A communication system including a host computer comprising:
processing circuitry configured to provide user data; and
a communication interface configured to forward user data to a cellular network for transmission to a User Equipment, UE;
wherein the UE comprises a radio interface and processing circuitry, the UE's components configured to perform any of the steps of any of the Group A embodiments.

Embodiment 38: The communication system of the previous embodiment, wherein the cellular network further includes a base station configured to communicate with the UE.

Embodiment 39: The communication system of the previous 2 embodiments, wherein:
the processing circuitry of the host computer is configured to execute a host application, thereby providing the user data; and
the UE's processing circuitry is configured to execute a client application associated with the host application.

Embodiment 40: A method implemented in a communication system including a host computer, a base station, and a User Equipment, UE, the method comprising:
at the host computer, providing user data; and
at the host computer, initiating a transmission carrying the user data to the UE via a cellular network comprising the base station, wherein the UE performs any of the steps of any of the Group A embodiments.

Embodiment 41: The method of the previous embodiment, further comprising at the UE, receiving the user data from the base station.

Embodiment 42: A communication system including a host computer comprising:
communication interface configured to receive user data originating from a transmission from a User Equipment, UE, to a base station;
wherein the UE comprises a radio interface and processing circuitry, the UE's processing circuitry configured to perform any of the steps of any of the Group A embodiments.

Embodiment 43: The communication system of the previous embodiment, further including the UE.

Embodiment 44: The communication system of the previous 2 embodiments, further including the base station, wherein the base station comprises a radio interface configured to communicate with the UE and a communication interface configured to forward to the host computer the user data carried by a transmission from the UE to the base station.

Embodiment 45: The communication system of the previous 3 embodiments, wherein:
the processing circuitry of the host computer is configured to execute a host application; and
the UE's processing circuitry is configured to execute a client application associated with the host application, thereby providing the user data.

Embodiment 46: The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

Embodiment 47: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 48: The method of the previous embodiment, further comprising, at the UE, providing the user data to the base station.

Embodiment 49: The method of the previous 2 embodiments, further comprising:
at the UE, executing a client application, thereby providing the user data to be transmitted; and
at the host computer, executing a host application associated with the client application.

Embodiment 50: The method of the previous 3 embodiments, further comprising:
at the UE, executing a client application; and
at the UE, receiving input data to the client application, the input data being provided at the host computer by executing a host application associated with the client application;
wherein the user data to be transmitted is provided by the client application in response to the input data.

Embodiment 51: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 52: The communication system of the previous embodiment further including the base station.

Embodiment 53: The communication system of the previous 2 embodiments, further including the UE, wherein the UE is configured to communicate with the base station.

Embodiment 54: The communication system of the previous 3 embodiments, wherein:
the processing circuitry of the host computer is configured to execute a host application; and
the UE is configured to execute a client application associated with the host application, thereby providing the user data to be received by the host computer.

Embodiment 55: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 56: The method of the previous embodiment, further comprising at the base station, receiving the user data from the UE.

Embodiment 57: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
ACK Acknowledgement
AF Application Function
AMF Access and Mobility Function
AN Access Network
AP Access Point
ASIC Application Specific Integrated Circuit
AUSF Authentication Server Function
BWP Bandwidth Part
CE Control Element
CP-OFDM Cyclic Prefix Orthogonal Frequency Division Multiplexing
CPU Central Processing Unit
CRC Cyclic Redundancy Check
DCI Downlink Control Information
DFT Discrete Fourier Transform
DL Downlink
DN Data Network
DSP Digital Signal Processor
eNB Enhanced or Evolved Node B
EPS Evolved Packet System
E-UTRA Evolved Universal Terrestrial Radio Access
FDM Frequency Domain Multiplexing
FH Frequency Hopping
FPGA Field Programmable Gate Array
gNB New Radio Base Station
gNB-DU New Radio Base Station Distributed Unit
HARQ Hybrid Automatic Repeat Request
HSS Home Subscriber Server
IoT Internet of Things
IP Internet Protocol
LTE Long Term Evolution
MAC Media Access Control
MME Mobility Management Entity
MTC Machine Type Communication
NACK Non-acknowledgement
NEF Network Exposure Function
NF Network Function
NR New Radio
NRF Network Function Repository Function
NSSF Network Slice Selection Function
OCC Orthogonal Cover Code
OFDM Orthogonal Frequency Division Multiplexing
OTT Over-the-Top
PC Personal Computer
PCF Policy Control Function
PDCCH Physical Downlink Control Channel
PDSCH Physical Downlink Shared Channel
P-GW Packet Data Network Gateway
PRB Physical Resource Block
PUCCH Physical Uplink Control Channel
PUSCH Physical Uplink Shared Channel
QoS Quality of Service
RAM Random Access Memory
RB Resource Block
RE Resource Element
RM Reed-Muller
RAN Radio Access Network
ROM Read Only Memory
RRC Radio Resource Control
RRH Remote Radio Head
RS Reference Signal
RTT Round Trip Time
SCEF Service Capability Exposure Function
SDM Spatial Division Multiplexing
SMF Session Management Function
SSB Synchronization Signal Block
SRS Sounding Reference Signal
TDM Time Domain Multiplexing
TRP Transmission and Reception Points
UCI Uplink Control Information
UDM Unified Data Management
UE User Equipment
UL Uplink
UPF User Plane Function
URLLC Ultra-Reliable Low Latency

Those skilled in the art will recognize improvements and modifications to the embodiments of the present disclosure. All such improvements and modifications are considered within the scope of the concepts disclosed herein.

1. A method of uplink transmission, performed by a User Equipment, UE, in a wireless communication network that includes two or more Transmission and Receiving Points, TRPs, each associated with a spatial relation or a Transmission Configuration Indication, TCI, state, the method comprising:
receiving, from a base station in the wireless communication network, a configuration of a first spatial relation and a second spatial relation or a configuration of a first TCI state and a second TCI state for an uplink channel resource, and an indication of N transmission repetitions of the uplink channel, wherein:
N is an integer greater than one; and
the first spatial relation and the second spatial relation or the first TCI state and the second TCI state are configured to form a mapping pattern over the transmission repetitions of the uplink channel, wherein the mapping pattern is cyclic mapping or sequential mapping;
receiving a Downlink, DL, Control Information, DCI, that indicates the uplink channel resource used for the transmission repetitions of the uplink channel; and
transmitting the uplink channel in N consecutive sub-slots in the uplink channel resource, and according to the mapping pattern, applying the first spatial relation or the first TCI state to the uplink channel transmission repetitions in a first subset of the sub-slots and applying the second spatial relation or the second TCI state to the uplink channel transmission repetitions in a second subset of the sub-slots.

2. The method of claim 1 wherein each of the first TCI state and the second TCI state is one of:
a unified TCI state that can be used for both downlink and uplink channel transmissions; and
an uplink TCI state that can be used only for uplink channel transmissions.

3. The method of claim 1 wherein the uplink channel is a Physical Uplink Control Channel, PUCCH.

4. The method of claim 1 wherein each of the first spatial relation and the second spatial relation comprises one or more of:
a Synchronization Signal Block, SSB, index, a Channel State Information Reference Signal, CSI-RS, index, or a Sounding Reference Signal, SRS, index, used to determine a spatial filter to be used for uplink channel transmission;
a pathloss reference signal index, and
one or more power control parameters.

5. The method of claim 1 wherein each of the first TCI state and the second TCI state comprises one or more of:
a Synchronization Signal Block, SSB, index, a Channel State Information Reference Signal, CSI-RS, index, or a Sounding Reference Signal, SRS, index, used to determine a spatial filter to be used for uplink channel transmission;
a pathloss reference signal index; and
and one or more power control parameters.

6. The method of claim 1 wherein a total number of sub-slots in the first subset of the sub-slots and the second subset of the sub-slots is equal to the number of transmission repetitions.

7. The method of claim 1 wherein the first subset of the sub-slots and the second subset of the sub-slots are in a same slot.

8. The method of claim 1 wherein each of the sub-slots comprises a number of Orthogonal Frequency Division Multiplexing, OFDM, symbols.

9. The method of claim 1 wherein the first subset of the sub-slots and the second subset of the sub-slots are non-overlapping in time.

10. The method of claim 1 wherein the same uplink channel resource is allocated in each of the sub-slots.

11. The method of claim 1 wherein the uplink channel is one of Physical Uplink Control Channel, PUCCH, formats 0 to 4.

12. The method of claim 1 wherein the first subset of the sub-slots includes one or more sub-slots, and the second subset of the sub-slots includes one or more sub-slots.

13. The method of claim 1 wherein the cyclic mapping of the first spatial relation and the second spatial relation or the cyclic mapping of the first TCI state and the second TCI state is configured over the repetitions of the uplink channel, wherein the first spatial relation or the first TCI state is applied to every other repetition of the uplink channel starting from the first repetition and the second spatial relation or the second TCI state is applied to the remaining repetitions.

14. The method of claim 13 wherein every other repetition of the uplink channel starting from the first repetition is transmitted in the first subset of the sub-slots, and the remaining repetitions are transmitted in the second subset of the sub-slots.

15. The method of claim 1 wherein the sequential mapping of the first spatial relation and the second spatial relation or the sequential mapping of the first TCI state and the second TCI state is configured over the repetitions of the uplink channel, wherein the first spatial relation or first TCI state is applied to every other two consecutive repetitions in time of the uplink channel starting from the first two consecutive repetitions and the second spatial relation or second TCI state is applied to the remaining repetitions.

16. The method of claim 15 wherein every other two consecutive repetitions of the uplink channel starting from the first repetition are transmitted in the first subset of the sub-slots, and the remaining repetitions are transmitted in the second subset of the sub-slots.

17. The method of claim 1 further comprising:
receiving, from the base station, a second configuration of multiple numbers of transmission repetitions for the uplink channel, wherein the number of transmission repetitions of the uplink channel is selected from the multiple numbers of transmission repetitions for the uplink channel depending on whether one or more of the following conditions are met:
two TCI states are indicated in a transmission configuration indication field of a DCI format scheduling an associated Physical Downlink Shared Channel, PDSCH, for which a corresponding Hybrid Automatic Repeat Request Acknowledgement, HARQ-ACK, is carried on the uplink channel;
an associated PDSCH corresponds to a particular PDSCH scheme;
a priority indicator field of a DCI scheduling an associated PDSCH is set to “1”;
an associated PDSCH is scheduled by DCI format 1_2;
the resource for the uplink channel is activated with two TCI states; and
a certain Uplink, UL, Control Information, UCI, type is carried by the uplink channel.

18. The method of claim 1 further comprising:
receiving, from the base station, a second configuration of multiple numbers of the transmission repetitions for the uplink channel, wherein the number of transmission repetitions of the uplink channel is selected from the multiple numbers of transmission repetitions for the uplink channel depending on a traffic type that the uplink channel is associated with.

19. The method of claim 1 further comprising receiving, from the base station, one or more configurations for selecting the number of transmission repetitions of the uplink channel, wherein one of the one or more configurations is dynamically indicated in the DCI.

20. The method of claim 1 wherein an Uplink Control Information, UCI, is carried by the uplink channel.

21. The method of claim 20 wherein the number of transmission repetitions of the uplink channel varies with a type of the UCI.

22. The method of claim 21 where the type of the UCI is one of: Hybrid Automatic Repeat Request, HARQ, Acknowledgement, ACK, Scheduling Request, SR, Channel State Information, CSI, or two or more of HARQ-ACK, SR, and CSI multiplexed together.

23. The method of claim 1 further comprising dropping one transmission repetition of the uplink channel when such transmission repetition of the uplink channel is overlapping with another uplink channel with a higher priority.

24-30. (canceled)

31. A User Equipment, UE, adapted to communicate in a wireless communication network that includes two or more Transmission and Receiving Points, TRPs, each associated with a spatial relation or Transmission Configuration Indication, TCI state, the UE comprising:
one or more transmitters;
one or more receivers; and
processing circuitry associated with the one or more transmitters and the one or more receivers, the processing circuitry configured to cause the UE to:
receive, from a base station in the wireless communication network, a configuration of a first spatial relation and a second spatial relation or a configuration of a first TCI state and a second TCI state for an uplink channel resource, and an indication of N transmission repetitions of the uplink channel, wherein:
N is an integer greater than one; and
the first spatial relation and the second spatial relation or the first TCI state and the second TCI state are configured to form a mapping pattern over the transmission repetitions of the uplink channel, wherein the mapping pattern is cyclic mapping or sequential mapping;
receive a Downlink, DL, Control Information, DCI, that indicates the uplink channel resource used for the transmission repetitions of the uplink channel; and
transmit the uplink channel in N consecutive sub-slots in the uplink channel resource, and according to the mapping pattern, applying the first spatial relation or the first TCI state to the uplink channel transmission repetitions in a first subset of the sub-slots, and applying the second spatial relation or the second TCI state to the uplink channel transmission repetitions in a second subset of the sub-slots.

32. (canceled)

33. A method of uplink transmission, performed by a base station, in a wireless communication network that includes two or more Transmission and Receiving Points, TRPs, each associated with a spatial relation or Transmission Configuration Indication, TCI state, the method comprising:
providing, to a user equipment, UE, in the wireless communication network, a configuration of a first spatial relation and a second spatial relation or a configuration of a first TCI state and a second TCI state for an uplink channel resource, and an indication of N transmission repetitions for transmitting the uplink channel, wherein:
N is an integer greater than one; and
the first spatial relation and the second spatial relation or the first TCI state and the second TCI state are configured to form a mapping pattern over the transmission repetitions of the uplink channel, wherein the mapping pattern is cyclic mapping or sequential mapping; and
providing a Downlink, DL, Control Information, DCI, to the UE, that indicates the uplink channel resource used for the transmission repetitions of the uplink channel.

34-48. (canceled)

49. A base station adapted to communicate in a wireless communication network that includes two or more Transmission and Receiving Points, TRPs, each associated with a spatial relation or Transmission Configuration Indication, TCI state, the base station comprising processing circuitry configured to cause the base station to:
provide, to a User Equipment, UE, in the wireless communication network, a configuration of a first spatial relation and a second spatial relation or a configuration of a first TCI state and a second TCI state for an uplink channel resource, and an indication of N transmission repetitions for transmitting the uplink channel, wherein:
N is an integer greater than one; and
the first spatial relation and the second spatial relation or the first TCI state and the second TCI state are configured to form a mapping pattern over the transmission repetitions of the uplink channel, wherein the mapping pattern is cyclic mapping or sequential mapping; and
provide a Downlink, DL, Control Information, DCI, to the UE, that indicates the uplink channel resource used for the transmission repetitions of the uplink channel.

50. (canceled)
